(19) United States
(12) Patent Application Publication
(10) Pub. No.: US 2026/0046695 A1
(43) Pub. Date: Feb. 12, 2026

(54) DECENTRALIZED MANAGEMENT OF WTRU STATE

(71) Applicant: InterDigital Patent Holdings, Inc., Wilmington, DE (US)

(72) Inventors: Michael Starsinic, Newtown, PA (US); Ulises Olvera-Hernandez, Saint-Lazare (CA); Saad Ahmad, Montreal (CA); Michel Roy, Candiac (CA); Samir Ferdi, Kirkland (CA); Rocco Di Girolamo, Laval (CA); Taimoor Abbas, Sainte-Julie (CA)

(73) Assignee: InterDigital Patent Holdings, Inc., Wilmington, DE (US)

(21) Appl. No.: 18/795,637

(22) Filed: Aug. 6, 2024

(51) Int. Cl. H04W 28/08; H04W 52/32; H04W 68/02; H04W 72/30

(52) U.S. Cl. CPC H04W 28/0967; H04W 52/322; H04W 68/02; H04W 72/30

(57) ABSTRACT

A RAN node may be configured to: receive, from a SMF, configuration information for a data session for a wireless transmit/receive unit (WTRU); determine a current state of the WTRU; and send, to a UPF, a first WTRU state notification message that may indicate the current state of the WTRU. The RAN node may be configured to receive, from the UPF, a DL data notification message that may indicate that the UPF has at least one PDU to send to the WTRU. The RAN node may be configured to: send, to the UPF, a DL data response message; send, to the WTRU, a paging message; and send, to the UPF, a second WTRU state notification that indicates that the WTRU is in a connected state. The RAN node may be configured to: receive, from the UPF, the PDU(s); and forward, to the WTRU, the PDU(s).

### BACKGROUND

For a wireless transmit/receive unit (WTRU) state in a 5G Core Network, the WTRU and 5G Core Network each maintain a Registration Management (RM) state for the WTRU. The WTRU and 5G Core Network each maintain a Connection Management (CM) state for the WTRU.

### SUMMARY

A radio access network (RAN) node may be configured to receive, from a session management function (SMF), configuration information for a data session for a wireless transmit/receive unit (WTRU). The RAN node may be configured to determine a current state of the WTRU. The RAN node may be configured to send, to a user plane function (UPF), a first WTRU state notification message. The first WTRU state notification message may indicate the current state of the WTRU. The current state may be an Idle state or an Inactive state. The RAN node may be configured to receive, from the UPF, a downlink (DL) data notification message. The DL data notification message may indicate that the UPF has at least one protocol data unit (PDU) to send to the WTRU. The RAN node may be configured to send, to the UPF, a DL data response message. The RAN node may be configured to send, to the WTRU, a paging message. The RAN node may be configured to send, to the UPF, a second WTRU state notification message. The second WTRU state notification message may indicate that the WTRU is in a connected state. The RAN node may be configured to receive, from the UPF, the at least one PDU. The RAN node may be configured to forward, to the WTRU, the at least one PDU. The configuration information for a data session may be used to communicate with the UPF. The first WTRU state notification message may comprise a data session identifier (ID) and a WTRU ID. The first WTRU state notification message may indicate how many PDUs that the RAN is capable of buffering for a data session for a quality of service (QoS) flow of the data session. The DL data notification message may comprise a QoS flow identifier (ID) and a differentiated services code point (DSCP) value. The RAN node may be configured to determine paging resources to send the paging message. The paging resources may be determined based on the QoS flow ID and the DSCP value. The paging resources may include what cells to use to broadcast the paging message and at what power to broadcast the paging message. The DL data notification message may include a PDU. The DL data response message may indicate an estimate of time for the WTRU's state to change to a Connected state. The RAN node may be configured to determine that the WTRU is in a connected state. The RAN node may be configured to forward the at least one PDU in response to the determination that the WTRU is in a connected state.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example procedure for user plane downlink data delivery when a WTRU is in an IDLE mode;

FIG. 3 shows an example procedure for control plane downlink data delivery when a WTRU is in an IDLE mode;

FIG. 4 shows an example procedure for control plane downlink data delivery during congestion;

FIG. 5 shows an example procedure for user plane downlink data delivery during congestion;

FIG. 6 shows an example procedure for user plane downlink data delivery during congestion;

FIG. 7 shows an example method for user plane downlink data delivery when a WTRU is in an IDLE mode;

FIG. 8 shows an example method for user plane downlink data delivery when a WTRU is in an IDLE mode; and

FIG. 9 shows an example method for user plane downlink data delivery with congestion when a WTRU is in an IDLE mode.

### DETAILED DESCRIPTION

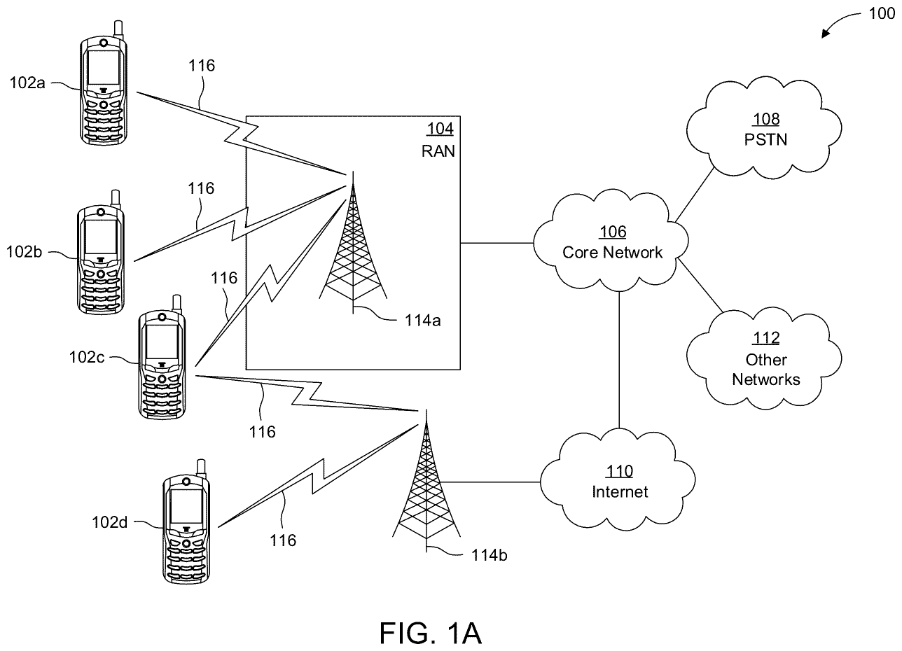

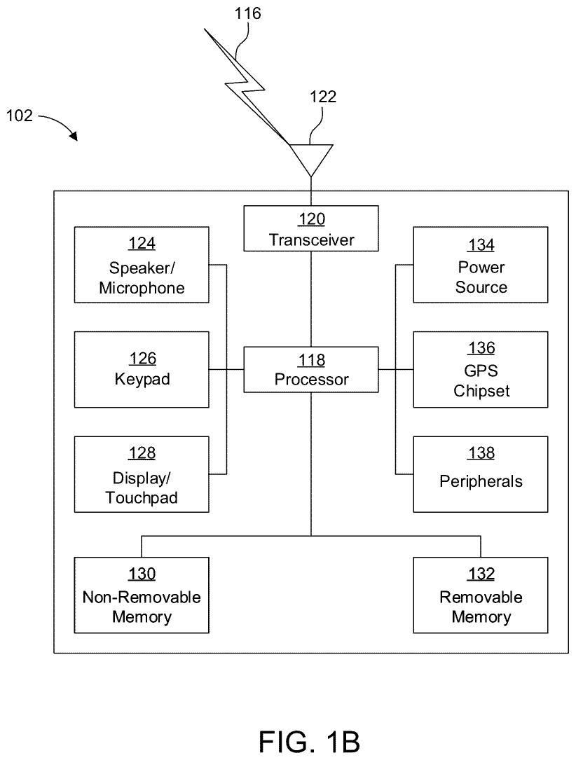

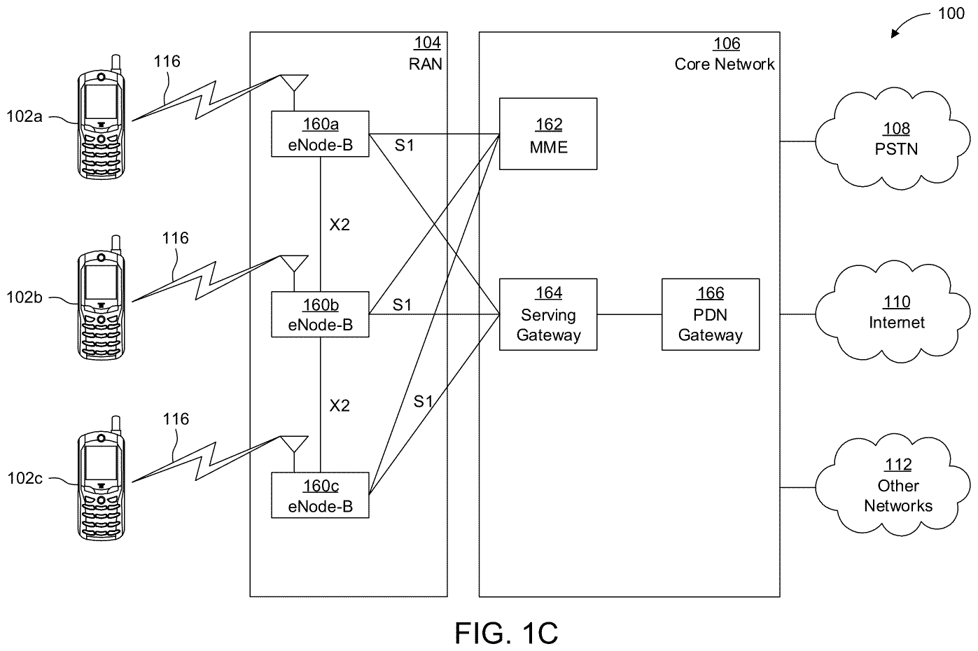

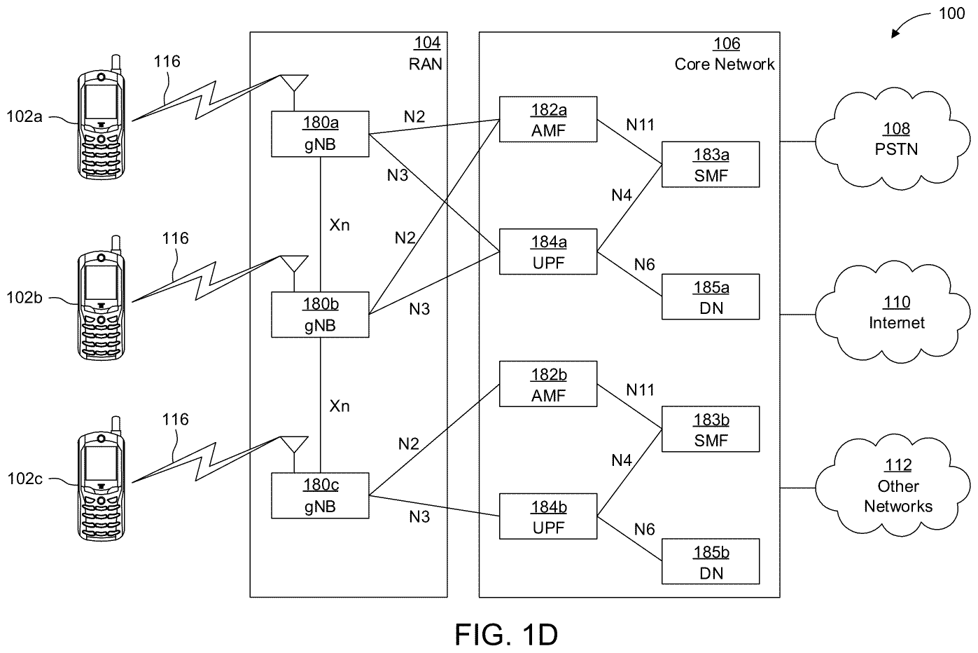

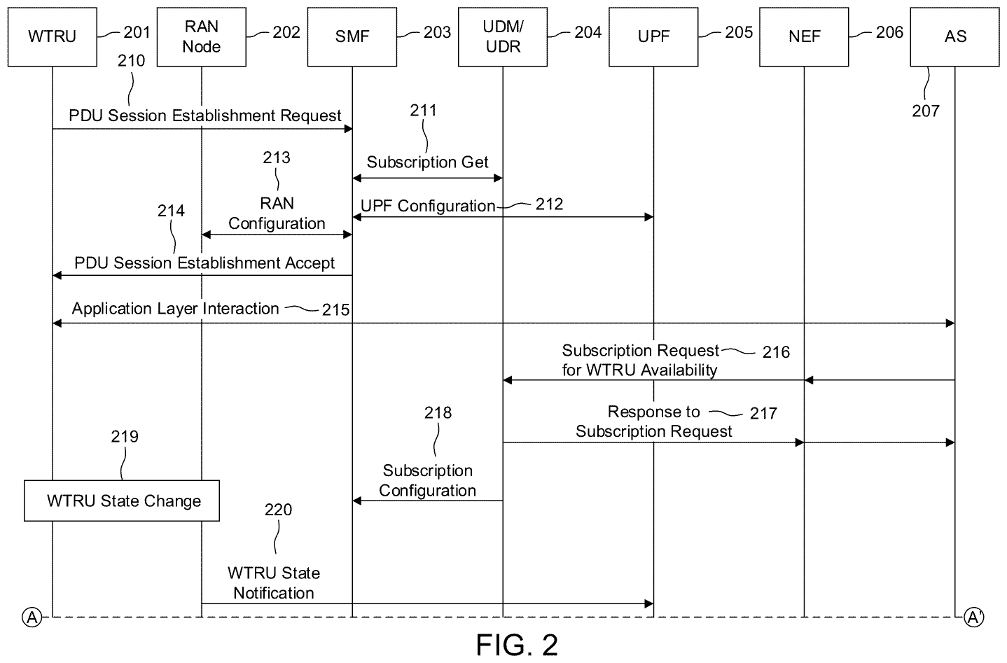

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The Registration Management (RM) procedures in the 5G system are used to register or deregister a WTRU/user with the network, and establish the user context in the network. Two RM states are used in the WTRU and an Access and Mobility Function (AMF). These states reflect the registration status of the WTRU in the selected Public Land Mobile Network (PLMN). The states are referred to as RM-DEREGISTERED and RM-REGISTERED.

In the RM-DEREGISTERED state, the WTRU is not registered with the network. In the RM-DEREGISTERED state, the WTRU context in the AMF holds no valid location or routing information for the WTRU, so the WTRU is not reachable by the AMF.

The WTRU and network (i.e. AMF) may perform a registration procedure and, if the registration procedure is successful, the WTRU and network will consider the WTRU to be in the RM-REGISTERED state.

In the RM REGISTERED state, the WTRU is registered with the network. In the RM-REGISTERED state, the WTRU may receive services that require registration with the network. Sending and receiving data is an example of a service that requires registration with the network.

The WTRU and network (i.e. AMF) may perform a de-registration procedure and, when the de-registration procedure is complete, the WTRU and network will consider the WTRU to be in the RM-DEREGISTERED state.

The Connection Management (CM) procedures in the 5G system are used to establish and release the signaling connection between the WTRU and the an AMF.

Connection management comprises the functions of establishing and releasing a Non-Access Stratum (NAS) signaling connection between a WTRU and the AMF over an N1 interface. The N1 interface is an interface between the WTRU and the AMF. This NAS signaling connection is used to enable NAS signaling exchange between the WTRU and the core network. It comprises both an Access Node (AN) signaling connection between the WTRU and the AN (e.g. radio resource control (RRC) Connection over 3GPP access or WTRU-non-3GPP interworking function (N3IWF) connection over untrusted N3GPP access or UE-TNGF connection over trusted N3GPP access) and an N2 connection for this WTRU between the AN and the AMF.

Two CM states are used in the WTRU and the AMF. These states reflect the status of the NAS signaling connection between the WTRU and AMF. The states are referred to as CM-IDLE and CM-CONNECTED.

A WTRU in the CM-IDLE state has no NAS signaling connection established with the AMF over N1. The WTRU cannot send or receive user plane data when the WTRU is in the CM-IDLE state. The network cannot send user plane data to the WTRU when the WTRU is in the CM-IDLE state.

If the WTRU needs to establish a NAS signaling connection, the WTRU must first transition to the CM-CONNECTED state. The WTRU may trigger a transition to the CM-CONNECTED state by sending an initial NAS message to the network. Registration Request, Service Request, or Deregistration Request are examples of initial NAS messages. Sending an initial NAS Message initiates the transition from a CM-IDLE to a CM-CONNECTED state.

When the WTRU is in the CM-IDLE state, the WTRU will monitor, or listen, for pages or paging messages from the network. If the network needs to send downlink data to the WTRU, the network must first trigger the WTRU to transition to the CM-CONNECTED state. The network may trigger the WTRU to transition to the CM-CONNECTED state by sending a paging message to the WTRU. Reception of the paging message will trigger the WTRU to transition to the CM-CONNECTED state by sending an initial NAS message to the network.

When the WTRU is in the CM-IDLE state, the WTRU's need to send uplink user plane data or a NAS message may trigger the WTRU to send an initial NAS message. When the WTRU is in the CM-IDLE state, the reception of a paging message may trigger the WTRU to send an initial NAS message.

A Network Triggered Service Request procedure may be triggered when the network (i.e. User Plane Function (UPF)) receives downlink data for a WTRU and the WTRU is in a CM-IDLE state.

When the WTRU is in the CM-IDLE state, there is no established tunnel between a UPF and a radio access network (RAN) Node. When the UPF receives downlink data for a WTRU that is in a CM-IDLE state, the UPF is not able to send the downlink data to the RAN Node that serves the WTRU. If there is no tunnel established between the RAN Node and the UPF, reception of downlink data by the UPF will trigger the UPF to send a Data Notification message to a Session Management Function (SMF). Reception of the Data Notification message will trigger the SMF to notify the AMF that data needs to be sent to the WTRU. Reception of the Data Notification message will trigger the AMF to send a paging message to the RAN Node. The paging message is a request for the RAN Node to page or send a paging message the WTRU. The paging message from the AMF will trigger the RAN Node to page or send a paging message to the WTRU. Reception of the paging message from the RAN Node will trigger the WTRU to initiate a service request procedure. Completion of the service request procedure will cause the WTRU to transition to a CM-CONNECTED state and will cause a tunnel to be established between the UPF and RAN Node. Once the tunnel is established between the UPF and RAN Node, the UPF may send the downlink data to the WTRU.

The design of the 5G System is such that a significant amount of interaction between the user plane (e.g. UPF) and control plane (e.g. AMF and SMF) needs to take place if the UPF receives data when the WTRU is in a CM-IDLE state. For example, reception of downlink data, by the network (e.g. UPF), while the WTRU is in the CM-IDLE state will cause the network to page or send a paging message to the WTRU and trigger a service request procedure.

An advantage to the existing 5G System design is that tunnels do not need to be maintained between the RAN Node and the UPF when the WTRU is in the CM-IDLE state. However, the disadvantage to this design is the user plane and control plane functions need to be more tightly coupled. When downlink data is received by the UPF for a WTRU that is in the CM-IDLE state, the UPF needs to notify the SMF, then the SMF needs to notify the AMF, and then the AMF needs to notify the RAN Node so that the WTRU may be paged, which adds complexity to the overall paging procedure.

The protocol that is used in the 5G System to send downlink data from the UPF to the RAN Node assumes that the WTRU is in the CM-CONNECTED state. Protocol enhancements are needed to enable the UPF to send downlink data even when the WTRU is in the CM-IDLE state. These enhancements would allow the UPF and the RAN Node to interact even when the WTRU is in the CM-IDLE state. Thus, interaction between the UPF, SMF, AMF, and RAN Node in order to trigger a paging procedure may be avoided with the possibility for the UPF to expedite the sending of downlink data to the WTRU.

Internet Protocol (IP) packets and protocol data units (PDUs) are examples of user plane data.

An IDLE state may generally refer to a state of a WTRU where the WTRU has a reduced connectivity with a network (e.g. base station) but may still be considered to be registered in the network. In an IDLE state, the WTRU may perform some mobility management procedures and monitor for paging messages from the network. The purpose of monitoring for paging messages is to determine if the WTRU is being paged. If the WTRU determines that it is being paged (i.e. receives a paging message), the WTRU may determine to initiate a procedure to transition out of the IDLE state and into a CONNECTED state. In a connected state, the WTRU may be able to send data to the network and receive data from the network.

AN RRC_IDLE state and an RRC_INACTIVE state are examples of IDLE states. RRC_IDLE and RRC_INACTIVE differ in that the amount of time that it takes for the WTRU to transition out of RRC_IDLE and the amount of time that it takes for the WTRU to transition out of RRC_INACTIVE may be different. For example, it may take the WTRU more time to transition out of RRC_IDLE compared to the amount of time that it takes to transition out of RRC_INACTIVE. The procedures for transitioning out of the RRC_IDLE state and the procedures for transitioning out of the RRC_INACTIVE state may be different. In a 5G network, the transition of a WTRU out of the RRC_IDLE state may cause a change on the WTRU's CM state. In the 5G network, the transition of a WTRU out of the RRC_INACTIVE state may not cause a change in the WTRU's CM state.

An RRC_CONNECTED state is an example of a CONNECTED state.

A non-access stratum (NAS) message is an example of a control plane message that may be sent from/to a function, or a service, of a core network to/from a WTRU.

A mobile terminated (MT) short message service (SMS) message may carry data for a user or application. However, since an MT SMS message is delivered over the control plane, an MT SMS message may be called a control plane message.

A NAS Message that carries non-IP data for a PDU session may carry data for a user or application. However, since non-IP data is delivered over the control plane, a non-IP data message may be called a control plane message.

The terms application server (AS), application function (AF), and Server may be used interchangeably herein.

N1 is a name of an interface in the 5G System. The N1 interface is between the WTRU and AMF. The N1 interface is used by the WTRU and AMF to exchange NAS messages. In the 5G System, a NAS message may originate from a network function other than the AMF (i.e. a second network function). However, the second network function must send the NAS message to the AMF so that the AMF may send the NAS message to the WTRU. In the 5G System, a NAS message may be sent to a network function other than the AMF (i.e. a second network function). However, the WTRU must send the NAS message to the AMF so that the AMF may send the NAS message to the second network function. The policy control function (PCF), session management function (SMF), SMS function (SMSF), and location management function (LMF) are examples of second network functions that may send and receive NAS messages.

N2 is a name of an interface in the 5G System. The N2 interface is between a RAN Node and an AMF. The N2 interface is used by the AMF and RAN Node to exchange next generation application protocol (NGAP) messages. Network functions other than the AMF may need to communicate with the RAN Node. For example, an SMF may need to send QoS profiles to the RAN Node. However, network functions that communicate with the RAN Node may need to communicate with the RAN Node via the AMF. For example, the SMF may send QoS profiles to the AMF so that the AMF may use the N2 interface to forward the QoS profiles to the RAN Node.

A PDU session is a session that may be used by a WTRU to send PDUs to a UPF so that the UPF may route, or send, the PDUs to a data network. A PDU session may also be used by a UPF to receive PDUs from a data network and route, or send, the PDUs to the WTRU. A user plane function (UPF) is a function that provides routing functionality, mapping of traffic to and from QoS flows, packet marking for QoS, and serves as a data plane anchor. The PDUs may be IP packets and may include the IP address of the WTRU. The PDUs maybe Ethernet frames and may include the MAC address of the WTRU. A PDU session may also be called a PDU “connection” in the sense that the session is used to connect the WTRU with a UPF that may be used to send and receive PDUs. A PDU session may also be called a “data” session in the sense that the session is used to connect the WTRU with a UPF that may be used to send and receive PDUs that carry data.

Uplink PDUs within a PDU session may be assigned to a QoS flow by the WTRU. Downlink PDUs within a PDU session may be assigned to a QoS flow by the UPF.

In the uplink, being assigned to a QoS flow means that a marking is applied to, or associated with, a PDU. The marking is applied by a service data adaption protocol (SDAP) layer of the WTRU. The marking may then be used by other layers within the WTRU to determine what QoS treatment to give the packet. In other words, the marking may then be used by other layers within the WTRU to determine how to prioritize the PDU.

In the downlink, being assigned to a QoS flow means that a marking is applied to, or associated with, a PDU. The marking is applied by the UPF. The marking may then be used by other network functions, including the RAN Node, to determine what QoS treatment to give the packet. In other words, the marking may then be used by other network functions, including the RAN Node, to determine how to prioritize the PDU.

The terms PDU and packet may be used interchangeably herein. For example, an Ethernet PDU (an Ethernet frame) is an Ethernet packet. For example, an IP PDU is an IP packet.

The terms RAN Node, base station, gNodeB (gNB), and eNodeB (eNB) may be used interchangeably herein.

The UPF is an example of a “user plane” network function in the 5G System. The UPF may receive configuration information from the SMF. The SMF is an example of a “control plane” network function in the 5G System. The PCF, AMF, SMSF, user data management (UDM), and user data repository (UDR) are also examples of “control plane” network functions in the 5G System.

CM_IDLE is an example of an IDLE state. CM_CONNECTED and “connected mode” are examples of CONNECTED states.

The term “reachable” as used herein, may generally refer to a situation where the network is able to send, and the WTRU is able to receive, a control plane message or data or generally refers to a situation where the network is able to trigger the WTRU to send a control plane message or data to the network. Paging a WTRU is a procedure that the network may use to trigger the WTRU to send a control plane message to the network. A WTRU that is reachable may be in an IDLE state and may periodically listen to the network, or monitor, for a paging message. If the WTRU does not periodically listen to the network, or monitor, for a paging message, the WTRU may not be reachable. The WTRU periodicity with which the WTRU listens to the network or monitors for a paging message may be determined based on the WTRU's discontinuous reception (DRX) cycle.

The term “unreachable” as used herein may generally refer to a situation where the network is not able to send a control plane message or data until the WTRU first initiates contact with the network. For example, a WTRU is considered “unreachable” when the WTRU is in a state where it does not listen to the network or monitor for a paging message. A WTRU that is “unreachable” may become “reachable” by sending a control plane message (e.g., an initial NAS message such as a registration request or a service request) to the network.

The terms handover and redirection may be used interchangeably herein. Handover may refer to a procedure where a WTRU moves it's point of attachment from a first cell to a second cell. The first and second cells may be associated with different RAN Nodes.

Reselection may refer to a procedure where a WTRU is camped on a first cell, determines that a second cell may better serve the WTRU, and determines to camp on the second cell instead of the first cell. In the 5G system, reselection is a procedure that takes place while the WTRU is in IDLE mode.

The terms mode and state may be used interchangeably herein.

Embodiments disclosed herein make the user plane and control plane less dependent on each other by introducing enhancements to the communication protocol that are used by network functions to communicate with the RAN Node. A UPF may subscribe to the RAN Node to receive information about a WTRU state information and to notify the RAN Node when the WTRU needs to transition to a CONNECTED state to receive user plane data. Network functions may subscribe to the RAN Node to receive information about a WTRU state information, to notify the RAN Node when the WTRU needs to transition to a CONNECTED state to receive control plane data, and to route control plane data to the WTRU.

The term “CONNECTED” state used herein implies a logic state whereby the WTRU is able to communicate with the network (e.g., receive data from the network). It does not necessarily require an active connection or network resources maintained in the network (e.g., as in the 5G core network (5GC)).

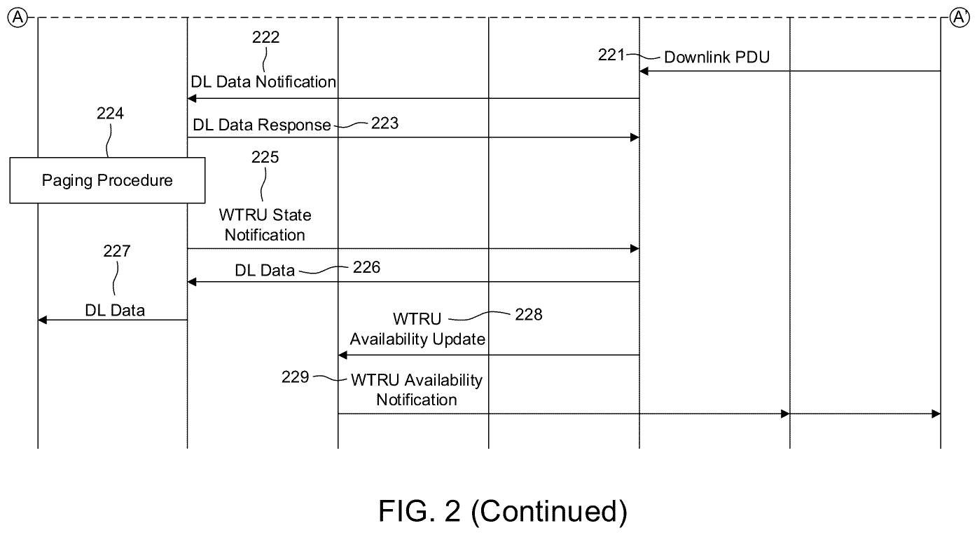

FIG. 2 shows an example procedure where downlink data is received at a UPF when the WTRU is in an IDLE mode. In the procedure of FIG. 1, the UPF may communicate directly with the RAN Node in order to coordinate the WTRU's change to a CONNECTED mode.

In 210, a WTRU 201 may send a request (e.g. a request message) to establish a data session with a network. The request may be sent to a session management function (SMF) 203 in the network. The request may indicate a data network name (DNN) and single-network slice selection assistance information (S-NSSAI) combination. The DNN may indicates a name of the data network that the WTRU needs to use the data session to send data to and receive data from. The S-NSSAI may indicates a type of network slice (i.e. the type of network functions) that should be used to manage the data session and send and receive the data. The data session may be a PDU session or a PDU connection. The data session may be used by the WTRU to send PDUs to a data network. The data session may be used by the WTRU to receive PDUs from a data network. The PDUs may be sent and received via a UPF 205. The UPF may be a gateway to a data network. The UPF may also be called a gateway.

In 211, the SMF 203 may obtain/receive WTRU subscription information from a user data repository (UDR) 204. For example, the SMF may send a subscription request message to the UDR and receive a subscription response message from the UDR. Communication between the SMF and UDR may be via a user data management (UDM). The SMF may obtain/receive subscription information that relates to the WTRU accessing the DNN and S-NSSAI combination. When the SMF requests the subscription information, the SMF may indicates a request to receive notifications about changes in the WTRU's subscription data.

In 212, the SMF may configure the UPF with information for the data session. The information may include information that may be used to send and receive data from the RAN Node 202. For example, the information may be tunnel endpoint information that may be used to establish a tunnel between the RAN Node and the UPF. The information may also include how to map downlink PDUs to QoS flows before the PDUs are sent to the WTRU via the RAN Node. The information for the data session may indicate to the UPF how many PDUs, or how much data, the RAN Node is able to buffer for the WTRU when the WTRU is in an IDLE state. The amount of data to buffer (e.g. in terms of PDUs or bytes) may be provided to the UPF on a per data session or a per QoS flow basis.

In 213, the SMF may configures the with RAN Node with information for the data session. The information may include information that may be used to send and receive data from the UPF. For example, the information may be tunnel endpoint information that may be used to establish a tunnel between the RAN Node and the UPF. The information may also include how to map downlink QoS flows to radio resources so that PDUs may be sent to the WTRU. The information for the data session may indicate to the RAN Node how many PDUs, or how much data, the RAN Node should/may buffer for the WTRU when the WTRU is in an IDLE state. The amount of data to buffer (e.g. in terms of PDUs or bytes) may be provided to the RAN node on a per data session or a per QoS flow basis.

In 214, the SMF may send a response to the WTRU's request for a data session with the network. The response may indicate that the data session was successfully established.

In 215, the WTRU and an Application Server (AS) 207 may establish an application layer session. The AS may determines the WTRU's IP address.

In 216, the AS may sends a subscription request (e.g. subscription request message) to the UDR. The subscription request may be sent via the network exposure function (NEF) 206 and UDM 204. The subscription request may indicate to the UDR that the AS requests a notification if the data that an AF sends to the WTRU is not delivered due to the WTRU being unreachable. The request may include the WTRU IP address. When the NEF forwards the request to the UDM/UDR, the NEF may also forward the NEF identification (ID) and a transaction identification (ID) to the UDR. The UDM/UDR may determine, based on the WTRU IP address, which data session the request is associated with.

In 217, the UDR may respond to the AS's subscription request (e.g. subscription request response message). The response may be sent to the AS via the UDM and NEF. The response may indicate that the subscription was successfully created.

In 218, the UDR may send a notification (e.g. subscription configuration message) to the SMF. The notification may be sent via the UDM. The notification may include the NEF ID, the transaction ID, and an indication that a notification should be sent if there is an attempt to send data via the data session and the WTRU is determined to be unreachable.

In 219, the WTRU may enter an IDLE or INACTIVE state. The WTRU may enter this state in coordination with the RAN Node. For example, the WTRU may send to the RAN Node a notification that the WTRU is entering this state. The WTRU may send the notification to the RAN Node based on the WTRU not sending or receiving data for a period of time. For example, the RAN Node may send the WTRU a command to enter this state. The RAN Node may send the command to the WTRU based on the WTRU not sending or receiving data for a period of time. The WTRU may exit this state by sending uplink traffic or sending a request to the network. For example, the WTRU may send an RRC message to the base station and the RRC message may carry or include a NAS message to the a network function, such as the AMF or SMF. The network may trigger the WTRU to exit this state by paging the WTRU (e.g. sending a paging message to the WTRU).

Note that, at this point in the procedure, control plane nodes in the core network may not be aware that the WTRU is in an IDLE or INACTIVE state. For example, network functions that perform mobility management, such as the AMF, do not need to be aware that the WTRU is in an IDLE or INACTIVE state. For example, network functions that perform session management, such as the SMF, do not need to be aware that the WTRU is in an IDLE or INACTIVE state.

In 220, the RAN Node may send a notification message (e.g. state notification message) to the UPF. The notification may include the data session identifier or an identifier of the WTRU. The notification message may indicate that the WTRU is in an IDLE state. The RAN Node may send the notification message to the UPF when the RAN Node receives a message from the WTRU that indicates that the WTRU should go into an IDLE state. The RAN Node may send the notification message to the UPF when the RAN Node sends a command to the WTRU and the command requests that the WTRU go into an IDLE state. The RAN Node may send the notification message to the UPF based on expiration of a timer or time period. For example, the RAN Node may reset a timer each time it receives a message from the WTRU. Expiration of the timer may be an indication that the RAN Node has not received a message from the WTRU in a certain amount of time.

In a scenario where the RAN Node sends the notification message to the UPF when the WTRU goes into an IDLE state, the RAN Node may be configured to only send the notification message to the UPF if the WTRU's DRX cycle is longer than a certain length of time. For example, if the WTRU's DRX cycle is relatively short (e.g. less than 10.24 seconds), then the RAN Node may determine that the WTRU may be paged and moved to a CONNECTED state rather quickly if downlink data needs to be sent to the WTRU and therefore the UPF does not need to be notified that the WTRU is in an IDLE state. Thus, in a scenario where the RAN Node determines that the expected amount of time that it will take to transition the RAN Node out of the IDLE state is small, the WTRU's state transitions can be “hidden” from the UPF, thus reducing the amount of messaging that is necessary between the RAN Node and UPF.

The notification message from the RAN Node to the UPF may indicate to the UPF how many PDUs that the RAN Node is willing to buffer for a data session or for each QoS flow of a data session. The notification message from the RAN Node to the UPF may indicate that how much (e.g. how many bytes) data the RAN Node is willing to buffer for a data session or for each QoS flow of a data session. This information may be used by the UPF to determine how many PDUs may be sent to the RAN Node before the UPF receives confirmation that the WTRU is in a CONNECTED state.

The notification message from the RAN Node to the UPF may indicate an expected maximum amount of time that it will take for the WTRU to change back to a connected state. For example, this time value may be based on the size of the WTRU's DRX cycle. This time value may be used by the UPF to configure timers in the UPF that may be used to determine if an attempt to deliver a PDU has failed. For example, this time value may be based on a timer that has been configured in the WTRU by the network and expiration of the timer may cause the WTRU to transition to a connected state and send a message to the network.

In step 221, the UPF may receive one or more PDUs for the PDU Session. The UPF may use the destination IP address or destination MAC address of the PDU to associate the PDU with a PDU Session and then the UPF may use information that was received in 212 to associate the PDU with a QoS flow.

In 222, the UPF may be triggered to send a downlink (DL) data notification (e.g. DL data notification message) to the RAN Node. The UPF may be triggered to send the DL data notification when the UPF receives the PDU(s) (e.g. in 221). The DL data notification may include a QoS flow identifier (ID) and/or a differentiated services code point (DSCP) value. The QoS flow ID and/or a DSCP value that are included in the notification may be the QoS flow ID and/or a DSCP value that is associated with the PDU(s) that are received (in 221). The UPF may include the QoS flow ID and/or a DSCP value in the DL data notification so that the RAN Node knows the relative importance of the PDU. For example, if the QoS flow ID and/or a DSCP value is associated with traffic that may be an attempt to establish a voice session with the WTRU, then the RAN Node may consider the PDU to be associated with traffic that is higher in priority. It is advantageous for the RAN Node to know the importance, or relative priority, of the traffic because the RAN Node may consider the importance, or relative priority, when forming a paging strategy. For example, if traffic is higher in importance, or relative priority, then the RAN Node may decide to initially use more paging resources when attempting to page the WTRU. Paging resources refers to the area over which a paging message is transmitted (i.e. the number of cells) and the power with which it is transmitted. The PDU set importance value that is associated with the PDU may also be sent to the RAN Node so that the RAN Node may consider the PDU set importance when forming a paging strategy.

The DL Data Notification to the RAN Node may optionally include a PDU (e.g. a PDU that was received in 221). For example, if the RAN Node indicated in 220 that the RAN Node is able to buffer at least one PDU, then the UPF may include the PDU when sending the DL data notification to the RAN Node. For example, if the SMF indicated in 211 that the RAN Node is able to buffer at least one PDU, then the UPF may include the PDU when sending the DL data notification to the RAN Node.

In 223, the RAN Node may send a DL data response (e.g. DL data response message) to the UPF. The DL data response may be sent to the UPF in response to the DL data notification. The DL data response may indicate to the UPF a time value or estimate of how long the RAN Node expects it will take for the WTRU's state to change to a connected mode after the RAN Node triggers the WTRU's transition to a connected mode. For example, the RAN Node may calculate or determine the time until the WTRU's next paging occasion and include a value that is close to this time in the DL data response to the UPF. The DL data response may indicate to the UPF that the WTRU is in a connected mode and that the PDU was delivered to the WTRU. The indication that the PDU was delivered may be interpreted as an indication that the WTRU is in a connected mode. When the RAN Node indicates that the WTRU is in connected mode, 224 and 225 may be skipped.

In 224, the RAN Node may send a paging message to the WTRU. The WTRU may respond to the RAN Node with a message that represents a request that the WTRU be allowed to transition to the CONNECTED state. Reception of the response may trigger the RAN Node to send a message to the WTRU to confirm that the WTRU is now in a CONNECTED mode.

In 225, the RAN Node may send a WTRU state notification message to the UPF. The WTRU state notification message may indicate to the UPF that the WTRU is now in a CONNECTED mode.

In 226, the UPF may send PDUs to the RAN Node. The PDUs may be the PDU(s) that were received in step 221. The UPF may be triggered to send the PDUs when the UPF receives the WTRU state notification message which indicates that the WTRU is in a CONNECTED mode. The UPF may be triggered to send the PDUs when a timer expires. For example, the UPF may configure a timer when it receives the DL data response message. The timer may be configured based on the amount of time that the RAN Node indicated that it would take for the WTRU's state to change to a connected mode. An advantage of triggering to send the PDUs based on expiration of the timer may be that the WTRU state notification message would not be necessary.

In 227, the RAN Node may send the PDU(s) to the WTRU.

In 228, the UPF may send a notification to the SMF to indicate that the WTRU is in connected mode. The UPF may be triggered to send this message based on reception of the WTRU state notification message or based on a timer expiring (e.g. the timer described in 226).

In 229, the SMF may send a notification to the AS to inform the AS that the WTRU is now in a CONNECTED mode. This message may be sent to the AS via the NEF. The SMF knows to send the message based on the configuration information that was received from the UDM/UDR in the subscription configuration message 218.

The protocol that is used to send messages and data between the RAN Node and UPF may be an enhanced version of GTP-U. For example, an enhanced version of GTP-U may be used send the WTRU state notification message 220, DL data notification message 222, DL data response message 223, WTRU state notification message 225 and the DL data 226 in the procedure of FIG. 2.

A GTP-U Tunnel Status information element may be enhanced to include a bit that indicates whether the WTRU whose data is carried in a GTP-U tunnel is in an IDLE state. Thus, the WTRU state notification message 220 and the WTRU state notification message 225 of FIG. 2 may be a GTP-U message that includes a GTP-U Tunnel Status information element and the GTP-U Tunnel Status information element may include a bit that indicates if the WTRU is in an IDLE state.

The GTP-U protocol may be enhanced to include a new information element that may be used to indicate how many PDUs that the RAN Node is willing to buffer for a data session or for each QoS flow of a data session. Thus, the WTRU state notification message 220 of FIG. 2 may be a GTP-U message that includes an information element that indicates how many PDUs that the RAN Node is willing to buffer for a data session or for each QoS flow of a data session.

The GTP-U protocol may be enhanced to include a new information element that may be used to indicate an expected maximum amount of time that it will take for the WTRU to change back to a connected state. Thus, the WTRU state notification message 220 of FIG. 2 may be a GTP-U message that includes an information element that indicates an expected maximum amount of time that it will take for the WTRU to change back to a connected state.

The GTP-U protocol may be enhanced to include a new information element that may be used to indicate to the UPF a time value or estimate of how long the RAN Node expects it will take for the WTRU's state to change to a connected mode. Thus, the DL data response message 223 of FIG. 2 may be a GTP-U message that includes an information element that indicates to the UPF a time value or estimate of how long the RAN Node expects it will take for the WTRU's state to change to a connected mode after the RAN Node triggers the WTRU's transition to a connected mode.

Other protocols may be used to communicate information between the RAN Node and the UPF. For example, SRv6 may be used to communicate information between the RAN Node and the UPF. The following information may be communicated between the RAN Node and the UPF in labels of the SRv6 protocol: an indication that the WTRU is in an IDLE state, an indication of how many PDUs that the RAN Node is willing to buffer for a data session or for each QoS flow of a data session, an expected maximum amount of time that it will take for the WTRU to change back to a connected state, and a time value or estimate of how long the RAN Node expects it will take for the WTRU's state to change to a connected mode after the RAN Node triggers the WTRU's transition to a connected mode.

In the procedure of FIG. 2, the WTRU may move to a different cell after the WTRU state notification message 220. For example, the WTRU may perform a handover procedure or a cell reselection procedure after sending the WTRU state notification message 220. The handover procedure or cell reselection procedure may cause the WTRU to be served by a different RAN Node.

When the RAN Node stops serving the WTRU, the RAN Node may send a notification to the UPF that a second RAN Node is now serving the WTRU. The notification may also indicate the identity and contact information of the second RAN Node. The RAN Node may also send information to the second RAN Node information about what notifications should be sent to the UPF.

Alternatively, the RAN Node may not immediately notify the UPF that a second RAN Node is now serving the WTRU. Instead, the RAN Node may wait until the DL data notification message 222 is received to trigger a notification of the UPF. The DL data response message 223 may include an indication that a second RAN Node is now serving the WTRU. The DL data response message 223 may also indicate the identity and contact information of the second RAN Node. Reception of the DL data response message 223 may trigger the UPF to send the DL data notification message 222 to the second RAN Node. The messages and procedures of 222 to 227 may be performed by the second RAN Node.

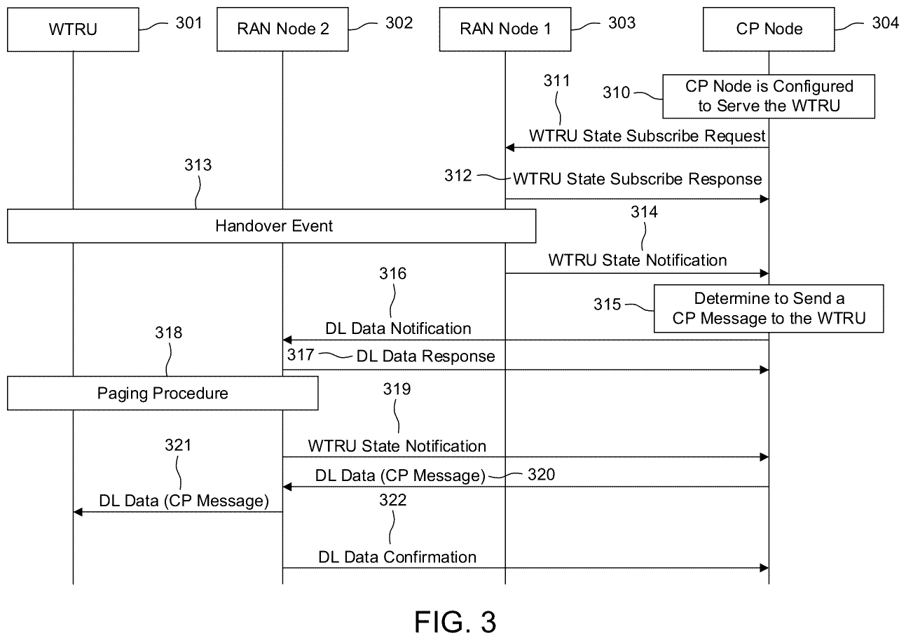

FIG. 3 shows an example procedure where control plane data needs to be delivered to the WTRU when the WTRU is in an IDLE mode. In the procedure of FIG. 3, a network function (NF) may communicate directly with a RAN Node in order to coordinate the WTRU's change to a CONNECTED mode. As described in the procedure of FIG. 3, the RAN Nodes may expose service-based interfaces that allow network functions to subscribe to the WTRU's state (i.e. IDLE or CONNECTED) and allow network functions to send control plane messages to the WTRU.

In 310, a control plane network function (i.e. Control Plane (CP) Node 304) may be configured to serve a WTRU 301. The network function may alternatively be an instance of services. For example, an AMF may receive a message from a RAN Node or another AMF that configures the AMF to serve the WTRU for system access and mobility procedures. For example, a PCF may receive a message from an AMF that configures the PCF to serve the WTRU for access and mobility polices. For example, a PCF may receive a message from an SMF that configures the PCF to serve a PDU Session (i.e. data session) of the WTRU for QoS rules and charging policies. For example, a SMF may receive a message from an AMF that configures the SMF to serve a PDU Session (i.e. data session) of the WTRU for session management. For example, a UDM may be configured by an operation administration and management (OAM) system to serve a WTRU for subscription information access. For example, an SMSF may receive a message from an AMF that configures the SMSF to serve a WTRU for sending and receiving SMS messages. The CP Node 304 may receive a message that notifies the CP Node that it has been selected to serve the WTRU. This message may identify the RAN Node that is currently serving the WTRU. In other words, the message may include a RAN Node ID. The message may also include a WTRU ID and may also include a temporary identifier of the WTRU. A 5G globally unique temporary identifier (5G-GUTI) is an example of a temporary ID. The temporary ID that is provided here may be constructed such that the RAN Node ID is part of the temporary ID. For example, the temporary ID may be an identifier that was assigned to the WTRU by the RAN Node and is therefore recognizable to the RAN Node.

In 311, the CP Node may send a subscription request message to the RAN Node (e.g. RAN Node 1 303) that currently serves the WTRU (e.g. send a WTRU subscribe request message). The CP Node may send the subscription request to the RAN Node that was identified in 310. The request may also include an identifier of the WTRU (e.g. the temporary identifier that was provided in 310).

A purpose of sending the subscription request to the RAN Node 1 is to request that the RAN Node 1 notify the CP Node if the RAN Node 1 stops serving the WTRU. For example, the RAN Node 1 may stop serving the WTRU if the WTRU de-registers from the system (e.g. when the WTRU is turned off) or the RAN Node 1 may stop serving the WTRU if the WTRU is “handed over” to be served by another RAN Node.

Another purpose of sending the subscription request to the RAN Node 1 is to request that the RAN Node 1 notify the CP Node if the WTRU's state changes. For example, the subscription request may request a notification if the WTRU moves to an IDLE state, if the WTRU moves out of an IDLE state, if the WTRU moves to a CONNECTED state, or if the WTRU moves out of a CONNECTED state. The subscription request may include a time value. The time value may represent an estimate of how long a delay the CP Node may tolerate between sending a control plane message to the WTRU and receiving a response from the WTRU or receiving a notification that the control plane message was delivered. The RAN Node 1 may use the time value to determine when to notify the CP Node about certain events. For example, if the time value is 8 seconds, the WTRU transitions to an IDLE state, and the RAN Node 1 expects that the WTRU will not remain in the IDLE state for more than 3 seconds, then the RAN Node 1 may determine that the CP Node does not need to be notified that the WTRU is in the IDLE mode. For example, if the time value is 8 seconds, the WTRU transitions to an IDLE state, and the RAN Node expects that it will not take more than 3 seconds to trigger the WTRU to move out of the IDLE state (i.e. page the WTRU and receive a response from the WTRU), then the RAN Node 1 may determine that the CP Node does not need to be notified that the WTRU is in the IDLE mode.

In 312, the RAN Node 1 may respond to the CP Node's subscription request (e.g. send a WTRU state subscribe response message). The response from the RAN Node 1 may indicate if the subscription request was accepted. The response may also indicate to the CP Node a time value or estimate of how long the RAN Node 1 expects it will take for the RAN Node 1 to trigger the WTRU to move out of the IDLE state (i.e. page the WTRU and receive a response from the WTRU). The response may also indicate the current state of the WTRU (i.e. IDLE or CONNECTED).

In 313, the WTRU, the RAN Node 1 and a second RAN Node (i.e. RAN Node 2 302) participate in a handover procedure or the WTRU performs a cell reselection procedure and selects a cell that is associated with the RAN Node 2. When the RAN Node 1 detects that the WTRU is now connected to the network via the RAN Node 2, the RAN Node 1 may send the subscription information that was configured in 311 and 312 and may be forwarded to the RAN Node 2. In other words, the RAN Node 2 may receive a message from the RAN Node 1 and the message may indicate that the CP Node should be notified if the RAN Node that is serving the WTRU changes. The RAN Node 2 may also receive information from the RAN Node 1 that indicates where the notification should be sent to (i.e. the address of the CP Node).

Instead of being triggered by a handover procedure, this procedure can also be triggered by a cell reselection procedure.

In 314, the RAN Node 1 may send a notification message (e.g. WTRU state notification message) to the CP Node to notify the CP Node that the RAN Node 2 is now serving the WTRU. The notification may include the identity of the RAN Node 2 and may include a new temporary identifier for the WTRU. The new temporary identifier for the WTRU may have been assigned by the RAN Node 2.

313 and 314 may be optional. For example, the WTRU may be stationary, and a handover procedure may not be executed. In a scenario where no handover procedure takes place, the RAN Node (i.e. RAN Node 1 in FIG. 3) and the second RAN Node (i.e. RAN Node 2 in FIG. 3) may be the same function.

In 315, the CP Node may determine to send a control plane message to the WTRU. The CP Node in this procedure may be a PCF that serves the WTRU for access and mobility policies. The PCF may initiate this procedure when the PCF determines that it needs to send updated policies to the WTRU. Examples of types of policies are access selection policies (i.e. access network discovery and selection policy (ANDSP)), PDU Session selection policies (i.e. UE/WTRU route selection policy (URSP)), vehicular to anything (V2X) communications policies (i.e. V2XP), proximity services (ProSe) operation policies (i.e. ProSeP), aircraft to anything (A2X) communication policies (i.e. A2XP), and/or Ranging/Sidelink Positioning (RSLPP) operation policies (i.e. RSLPP).

The CP Node may be a UDM. The UDM may initiate this procedure when the UDM determines that it needs to send updated information to the WTRU. Steering or roaming information is an example of information that the UDM may need to send to the WTRU.

The CP Node may be a PCF that serves a WTRU's PDU Session (i.e. data session). The PCF may initiate this procedure when the PCF determines that it needs to send updated QoS rules to the WTRU. In the 5G System, the SMF may send QoS rules to the WTRU. It can be appreciated that the architecture and procedures that are presented herein may enable to the PCF that serves the PDU Session to generate QoS rules and send the QoS rules to the WTRU.

The CP Node may be an SMF that serves a WTRU's PDU Session (i.e. data session). The SMF may initiate this procedure when the SMF determines that it needs to send updated QoS rules to the WTRU. For example, the SMF may initiate this procedure when the SMF needs to send a PDU Session Modification command to the WTRU. The PDU Session Modification command may be used to carry the updated QoS rules to the WTRU. In an example, the SMF may initiate this procedure when the SMF determines to release the PDU Session and the SMF ay send a PDU Session Release Message to the WTRU. In an example, the SMF may initiate this procedure when the SMF needs to send an Application Layer payload to the WTRU. For example, the Application Layer payload may have been received by the SMF from the NEF.

The CP Node may be an NEF that serves a WTRU's PDU Session (i.e. data session). The NEF may initiate this procedure when the NEF determines that it needs to send an application layer payload from an AF to the WTRU. In the 5G System, the NEF may send application layer payload to the WTRU via the SMF. However, it can be appreciated that the architecture and procedures that are presented herein may enable to the NEF that serves the PDU Session to send application layer payloads to the WTRU.

The CP Node may be an AMF that serves that serves the WTRU. The AMF may initiate this procedure when the AMF determines that it needs to send a new allowed NSSAI, partially allowed NSSAI, rejected S-NSSAI(s), partially rejected S-NSSAI(s) or configured NSSAI to the WTRU. The AMF may initiate this procedure when the AMF determines that it needs to send a NAS message to the WTRU. A NAS message may carry a downlink data notification.

The CP node may be an SMSF that serves that serves the WTRU. The SMSF may initiate this procedure when the SMSF determines that it needs to send a MT SMS message to the WTRU.

In 316, the CP Node may send a notification message to the RAN Node 2 (e.g. DL data notification message). This message may notify the RAN Node 2 that the CP Node needs to deliver a control plane message to the WTRU. The message may include an indication of the relative importance of the control plane message that needs to be sent to the WTRU. For example, if the control plane message indicates that a slice is no longer allowed (i.e. a new rejected S-NSSAI) then the indication may indicate that the control plane message is relatively high in importance. For example, if the control plane message indicates carries a MT SMS message, then the indication may indicate that the control plane message is relatively low in importance. The importance value may be used by the RAN Node 2 to infer the amount of relative delay that is acceptable for delivering the message and therefore used by the RAN Node 2 to form a paging strategy for the WTRUI. For example, if the message is relatively important, then the RAN Node 2 may initially page the WTRU over a relatively wider area compared to the if the message is relatively lower in importance. The notification message may optionally include the control plane message.

In 317, the RAN Node 2 may send a response message (e.g. DL data response message) to the CP Node. The response message may indicate that the WTRU is in a CONNECTED mode or if that the WTRU is in an IDLE mode.

If the DL data notification message includes the control plane message, the DL data response message may indicate if the RAN Node 2 will attempt to deliver the message and how much delay may be expected for delivery of the message. For example, the amount of delay that is indicated may be based on the size of the WTRU's DRX cycle.

If the WTRU is in an IDLE mode, the DL data response message may indicate that the WTRU is in an IDLE mode and may further indicate a time value or estimate of how long the RAN Node 2 expects it will take for the WTRU to move to a connected state (i.e. how long it will take before a response to a page is received from the WTRU). The response message may include a relative time value or an absolute time value. The time value may be used by the CP Node to determine when the CP Node should send the control plane message to the RAN Node 2. The time value may also be used by the CP Node to determine when the CP Node should expect confirmation that the control plane message was delivered to the WTRU. The RAN Node 2 may use the time of the WTRU's next paging occasion to determine the time value. For example, RAN Node 2 may use the WTRU's DRX cycle to calculate or determine the WTRU's next paging occasion.

In 318, the RAN Node 2 may initiate a paging procedure (e.g. send a paging message to the WTRU). The RAN Node 2 may use the relative importance of the control plane message, which was indicated in the DL data notification 316, to form a paging strategy. Forming a paging strategy may mean determining which cells to broadcast the paging message from and which what power to broadcast the paging message. The WTRU may respond to the paging message and an RRC Connection may be established between the WTRU and RAN Node 2. When the paging procedure completes, the WTRU may be in a CONNECTED mode.

In 319, the RAN Node 2 may send a notification to the CP Node (e.g. WTRU state notification message) to notify the CP Node that the WTRU is now in CONNECTED mode. The notification may include a time value that represents how long the WTRU will stay in a CONNECTED mode before returning to an IDLE mode unless new traffic is sent to the WTRU. In other words, the notification may include a time value that represents how long the WTRU's RRC Connection will be maintained unless new traffic is sent to the WTRU.

In 320, the CP Node may send a control plane message (e.g. DL data CP message) to the RAN Node 2.

319 and 320 may not be necessary if the CP Node sends the control plane message to the RAN Node 2 in the DL data notification message 316.

In 321, the RAN Node 2 may send the control plane message (e.g. DL data CP message) to the WTRU.

In 322, the RAN Node 2 may send a message to the to the CP Node (e.g. DL data confirmation message) to confirm delivery of the control plane message.

In the procedure of FIG. 2, the CP Node may inform that the RAN Node 1 in 311 that the CP Node is serving the WTRU. The CP Node may provide the RAN Node 1 with information about the relative importance of the data that the CP Node may need to send to the WTRU or the CP Node may provide the RAN Node with information about the type of service that the CP Node is associated with (e.g. V2X Services or Internet Traffic).

In the procedure of FIG. 2, the SMF may informs the RAN Node in 213 about the QoS requirements of the data session.

The RAN Node may use the information about the QoS requirements of the WTRU's data sessions and the expected importance of the traffic from the CP Nodes to configure an inactivity timer (e.g. time value) in/for the WTRU. The inactivity timer may be a timer that the WTRU resets each time the WTRU sends traffic or receives traffic. The WTRU may enter an IDLE state when the inactivity timer expires.

The RAN Node may use the information about the QoS requirements of the WTRU's data sessions and the expected importance of the traffic from the CP Nodes to configure the size of the WTRU's DRX cycle. For example, if some of the WTRU's traffic requires relatively low latency, then the RAN Node may configure the WTRU with a relatively short DRX cycle. For example, if none of the WTRU's traffic requires relatively low latency, then the RAN Node may configure the WTRU with a relatively longer DRX cycle.

The RAN Node may use the information about the QoS Requirements of the WTRU's data sessions and the expected importance of the traffic from the CP Nodes to configure an update timer in the WTRU. The update timer may be a timer that the WTRU runs when the WTRU is in an IDLE mode and expiration of the timer may trigger the WTRU to transition to a CONNECTED state and send a message to the RAN Node.

Note that, compared to the existing procedures in the 5G system, the procedures of FIG. 2 and FIG. 3 enable faster paging of the WTRU. For example, when the WTRU is in an IDLE mode, the procedure of FIG. 2 allows the UPF to immediately send data to the RAN Node. This is more efficient than the existing procedure in the 5G system where the UPF would have to notify the SMF so that the SMF may request that the AMF page the WTRU and the AMF may forward the paging request to the RAN Node. For example, when the WTRU is in an IDLE mode, the procedure of FIG. 3 allows the CP Node to immediately send data to the RAN Node. This is more efficient than the existing procedure in the 5G system where the CP Node would have to send the data via the AMF and the AMF would have to trigger paging of the WTRU. Since the time between MT data being available and the RAN detecting that the WTRU needs to be paged is relatively shorter, it is possible to configure the WTRU with a relatively shorter inactivity timer, thus the WTRU may be able to conserve more power by spending more time in an IDLE state.

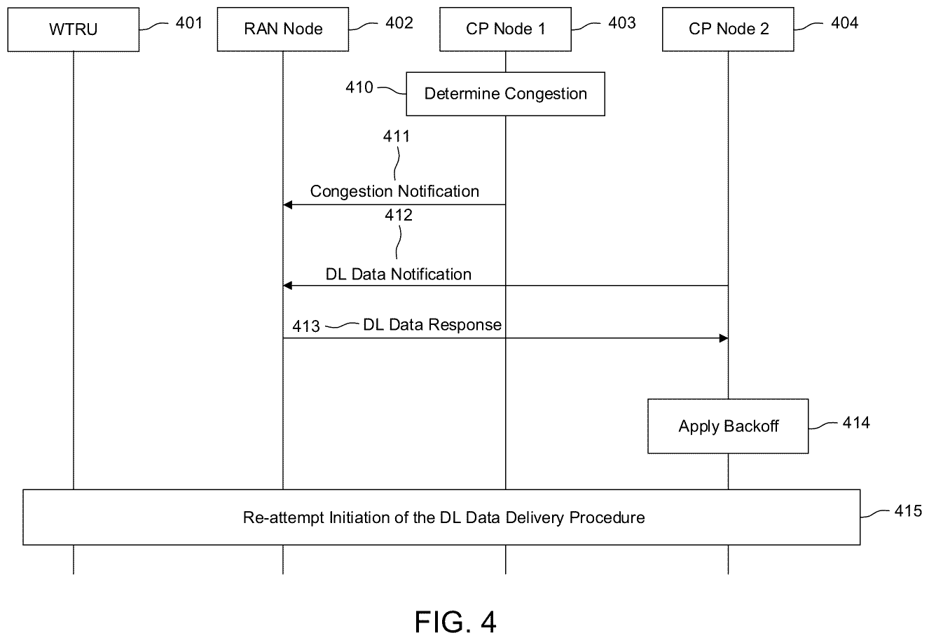

FIG. 4 shows an example procedure where a first control plane node (i.e. CP Node 1 403) determines that there is a congestion situation in the network. The control plane node may send a congestion notification message to the RAN Node 402 that is serving the WTRU 401 about the congestion. The congestion notification may indicate what types of transactions should be prevented during the congestion situation and the congestion notification may include a time value that represent how long the RAN Node 402 should assume that the congestion situation applies. The procedure of FIG. 4 shows how the RAN Node 402 may use the information in the congestion notification to apply a back off to requests that are initiated by other control plane nodes (i.e. CP Node 2 402).

In 410, a core network node (i.e. CP Node 1 403) or the OAM system may determine that there is a congestion situation in the core network. A core network node may determine that there is congestion in the network based on the number of message delivery attempts that fail over a time period. Message delivery attempts refers to attempts to deliver a message to a WTRU, RAN Node, or another CP Node. A core network node may determine that there is congestion in the network based on the number of timers that expire over a time period. Expiration of a timer refers to a timer, which keeps track of how much time has passed between sending a request and receiving a response. A core network node may determine that there is congestion in the network based on the number of WTRUs that or sessions that the core network node is associated with. An OAM system may determine that there is a congestion situation in the core network based on analytics and information that the OAM system receives from RAN Nodes and CP Nodes.

In 410, CP Node 1 may be the OAM System. The OAM System may determine that certain core network nodes are congested.

In 410, CP Node 1 may be an SMF or a PCF. The SMF or PCF may determine that certain data sessions are congested.

In 410, CP Node 1 may be an AMF. The AMF may determine that all control plane nodes and/or user plane nodes that are associated with a certain WTRU or a certain groups of WTRU's are congested. In 410, CP Node 1 may be an SMSF. The SMSF may determine that the SMSF is congested.

In 410, CP Node 1 may be a PCF. The PCF may determine that the PCF is congested.

In 411, CP Node 1 403 may send a congestion notification message to the RAN Node 402.

Alternatively, the RAN Node may determine that there is a congestion situation without receiving a notification from another node.

The congestion notification message may include a time value that represents how long the RAN Node should assume that the congestion situation applies. Before the congestion time expires, CP Node 1 may notify the RAN Node that the congestion situation has be resolved or CP Node 1 may extend the congestion time.

CP Node 1 may be an SMF or a PCF. The SMF or PCF may include a data session identifier (e.g. a PDU Session Identifier) in the congestion notification message to which the congestion notification applies.

CP Node 1 may be an AMF. The AMF may include a WTRU identifier or an identifier of a group of WTRUs in the congestion notification message to which the congestion notification applies.

CP Node 1 may be an SMSF. The SMSF may include a WTRU identifier or an identifier of a group of WTRUs in the congestion notification message to which the congestion notification applies. Furthermore, the congestion notification message may indicate that the congestion only applies to traffic that is directed to the SMSF, certain SMSFs, or certain networks.

CP Node 1 may be a PCF. The PCF may include a WTRU identifier or an identifier of a group of WTRUs in the congestion notification message to which the congestion notification applies. Furthermore, the congestion notification message may indicate that the congestion only applies to traffic that is directed to the PCF or certain PCFs.

In 412, CP Node 2 404 may send a DL data notification message to the RAN Node. This is similar to the DL data notification 316 of the procedure of FIG. 3.

In 413, the RAN Node may send a DL data response message to CP Node 2. Before sending the DL data response the RAN Node may determine that the DL data notification message 412 is related to the congestion situation that the RAN Node was notified about in the congestion notification message 411.

For example, the congestion notification message 411 may have indicated that all of a WTRU's traffic is associated with a congestion situation. The DL data notification message 412 may be a message that may indicate or trigger the sending of a control plane message to a WTRU that was identified in the congestion notification message 411 or a WTRU that is a member of a group of WTRUs that was identified in the congestion notification message 411. The RAN Node may then determine to respond in the DL data response message 413 with an indication of congestion and a back off timer value. The back off timer value may be based on the time value that was received in the congestion notification message 411 and how much time passed since receiving the congestion notification message 411.

In 414, CP Node 2 may apply the back off timer value that was received in the DL data response message 413. Applying the back off timer value may mean that the CP Node 2 may configure a timer based on the received back off timer value and, when the timer expires, CP Node 2 may attempt again to deliver the DL data.

In 415, CP Node 2 may attempt again to deliver the DL data by performing the DL data notification 316 of the procedure of FIG. 3. The RAN Node may respond by performing the DL data response 317 of the procedure of FIG. 3. If the response from the RAN Node does not indicate that there is congestion in the network, then the procedure may continue by performing 318-322 of the procedure of FIG. 3. If the response from the RAN Node indicates that there is congestion in the network, then this procedure may return to 414 so that CP Node 2 may apply the back off time.

If CP Node 2 attempts to deliver the DL data again, and the RAN Node again indicates that the delivery attempt cannot be completed (e.g. because the congestion situation has not been removed), CP Node 2 may run a back off timer and attempt again. CP Node 2 may be configured to stop initiating delivery attempts after a number of failed attempts. When CP Node 2 decides to stop initiating delivery attempts, CP Node 2 may subscribe to the RAN Node to receive a notification when a delivery attempt may be retried. For example, if CP Node 2 determines that the information that it needs to send to the WTRU is important (e.g. a policy update) and must be delivered to the WTRU at some point, then CP Node 2 may subscribe to the RAN Node to receive a notification when a delivery attempt may be retried.

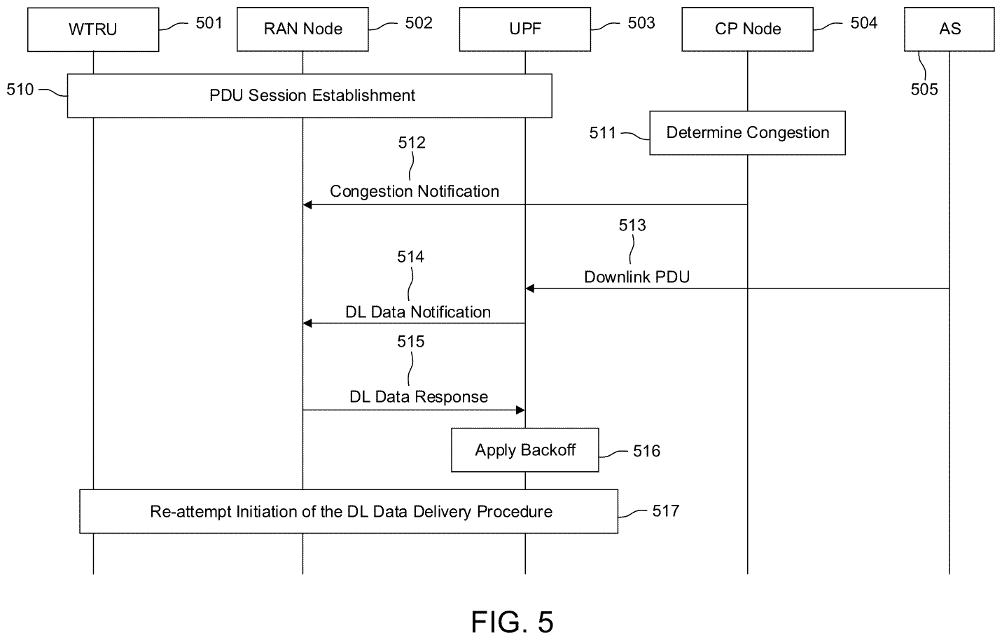

FIG. 5 shows an example procedure where a control plane node (i.e. CP Node 504) may determine that there is a congestion situation in the network. The control plane node may send a notification to the RAN Node 502 that is serving the WTRU 501 about the congestion. The congestion notification may indicate what types of transactions should be prevented during the congestion situation and the congestion notification may include a time value that represent how long the RAN Node should assume that the congestion situation applies. The procedure of FIG. 5 shows how the RAN Node may use the information in the congestion notification to apply a back off to requests that are initiated by user plane functions (e.g. the UPF 503).

In 510, the UPF 503, the WTRU 501, and the RAN Node 502 may perform a PDU Session Establishment procedure. For example, 210 through 220 of the procedure of FIG. 2 may be performed.

In 511, a core network node (i.e. CP Node 504), or the OAM system, may determine that there is a congestion situation in the core network.

In 511, the CP Node may be the OAM System. The OAM System may determine that certain core network nodes are congested.

In 511, the CP Node may be an SMF or a PCF. The SMF or PCF may determine that certain data sessions are congested.

In 511, the CP Node may be an AMF. The AMF may determine that all control plane nodes and/or user plane nodes that are associated with a certain WTRU or a certain groups of WTRU's are congested.

In 511, the CP Node may be an SMSF. The SMSF may determine that the SMSF is congested.

In 511, the CP Node may be a PCF. The PCF may determine that the PCF is congested.

In 512, the CP Node 504 may send a congestion notification message to the RAN Node 502.

The congestion notification message may include a time value that represents how long the RAN Node should assume that the congestion situation applies. Before the congestion time expires, the CP Node may notify the RAN Node that the congestion situation has be resolved or the CP Node may extend the congestion time.

The CP Node may be an SMF or a PCF. The SMF or PCF may include a data session identifier (e.g. a PDU Session Identifier) in the congestion notification message to which the congestion notification applies.

The CP Node may be an AMF. The AMF may include a WTRU identifier or an identifier of a group of WTRUs in the congestion notification message to which the congestion notification applies.

The CP Node may be an SMSF. The SMSF may include a WTRU identifier or an identifier of a group of WTRUs in the congestion notification message to which the congestion notification applies. Furthermore, the congestion notification message may indicate that the congestion only applies to traffic that is directed to the SMSF, certain SMSFs, or certain networks.

The CP Node may be a PCF. The PCF may include a WTRU identifier or an identifier of a group of WTRUs in the congestion notification message to which the congestion notification applies. Furthermore, the congestion notification message may indicate that the congestion only applies to traffic that is directed to the PCF or certain PCFs.

In 513, the UPF receives a PDU from an AS. This step is as described in step 12 of the procedure of FIG. 1

In 514, the UPF 503 may send a DL data notification message to the RAN Node. The sending of the DL data notification message may be as described in 222 of the procedure of FIG. 2.

In 515, the RAN Node may send a DL data response message to the UPF. Before sending the DL data response message, the RAN Node may determine that the DL data notification 514 is related to the congestion situation that the RAN Node was notified about in the congestion notification message 512.

For example, the congestion notification message 512 may have indicated that all of a WTRU's traffic is associated with a congestion situation or the congestion notification message 512 may have indicated that all traffic that is associated with the PDU Session (i.e. the data session) is associated with a congestion situation. The DL data notification 514 may be a request to send user plane data for a WTRU that was identified in the congestion notification message 512 or a WTRU that is a member of a group of WTRUs that was identified in the congestion notification message 512. The RAN Node may then determine to respond in the DL data response message 515 with an indication of congestion and a back off timer value. The back off timer value may be based on the time value that was received in the congestion notification message 512 and how much time passed since receiving the congestion notification message 512.

In 516, the UPF may apply the back off timer value that was received in the DL data response message 515. Applying the back off timer value may mean that the UPF may configure a timer based on the received back off timer value and, when the timer expires, attempts again to deliver the DL data.

In 517, the UPF may attempts again to deliver the DL data by performing, for example, 222 through 229 of the procedure of FIG. 2.

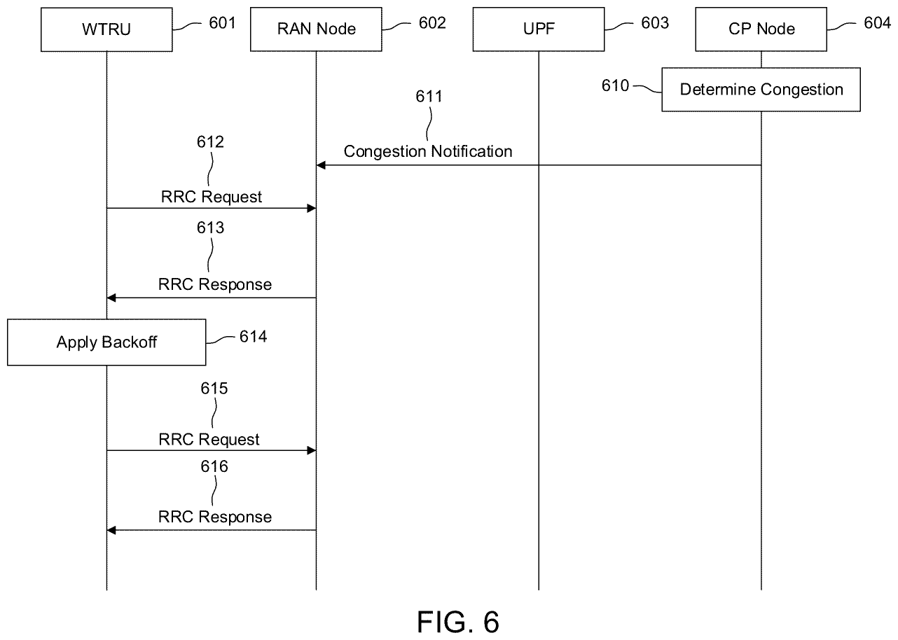

FIG. 6 shows an example procedure where a control plane node (i.e. CP Node 604) may determine that there is a congestion situation in the network. The control plane node may send a notification (e.g. congestion notification message) to the RAN Node 602 that is serving the WTRU 601 about the congestion. The congestion notification may indicate what types of transactions should be prevented during the congestion situation and the congestion notification may include a time value that represent how long the RAN Node should assume that the congestion situation applies. The procedure of FIG. 6 shows how the RAN Node may use the information in the congestion notification to apply a back off to requests that are initiated by the WTRU.

In 610, a core network node (i.e. CP Node 604), or the OAM system, may determine that there is a congestion situation in the core network.

In 610, the CP Node may be the OAM System. The OAM System may determine that certain core network nodes are congested.

In 610, the CP Node may be an SMF or a PCF. The SMF or PCF may determine that certain data sessions are congested.

In 610, the CP Node may be an AMF. The AMF may determine that all control plane nodes and/or user plane nodes that are associated with a certain WTRU or a certain groups of WTRU's are congested.

In 610, the CP Node may be an SMSF. The SMSF may determine that the SMSF is congested.

In 610, the CP Node may be a PCF. The PCF may determine that the PCF is congested.

In 611, the CP Node 604 may send a congestion notification message to the RAN Node 602.

The congestion notification message may include a time value that represents how long the RAN Node should assume that the congestion situation applies. Before the congestion time expires, the CP Node may notify the RAN Node that the congestion situation has be resolved or the CP Node may extend the congestion time.

The CP Node may be an SMF or a PCF. The SMF or PCF may include a data session identifier (e.g. a PDU Session Identifier) in the congestion notification message 611 to which the congestion notification applies.

The CP Node may be an AMF. The AMF may include a WTRU identifier or an identifier of a group of WTRUs in the congestion notification message 611 to which the congestion notification applies.

The CP Node may be an SMSF. The SMSF may include a WTRU identifier or an identifier of a group of WTRUs in the congestion notification message 611 to which the congestion notification applies. Furthermore, the congestion notification may indicate that the congestion only applies to traffic that is directed to the SMSF, certain SMSFs, or certain networks.

The CP Node may be a PCF. The PCF may include a WTRU identifier or an identifier of a group of WTRUs in the congestion notification message 611 to which the congestion notification applies. Furthermore, the congestion notification may indicate that the congestion only applies to traffic that is directed to the PCF or certain PCFs.

In 612, the WTRU 601 may determine that it needs to establish an RRC Connection in order to send a control plane message to the core network (e.g. a NAS message) or in order to send uplink user plane data. The WTRU may send an RRC request message to the network to request establishment of an RRC Connection. The RRC request message may include an establishment cause.

The establishment cause may indicate that the RRC Connection will be used to send uplink user plane data. If the establishment cause indicates that the RRC Connection will be used to send uplink user plane data, then the RRC request message may also identify what data session(s) the WTRU plans to send uplink data for.

The establishment cause may indicate that the RRC Connection will be used to send a control plane message to the core network (e.g. a NAS message). If the establishment cause indicates that the RRC Connection will be used to send a control plane message to the core network, then the RRC request message may also indicate what network function or service the control plane message needs to be sent to.

In 613, the RAN Node may send an RRC response message to the WTRU. Before sending the RRC response message, the RAN Node may determine that the RRC request message 612 is related to the congestion situation that the RAN Node was notified about in the congestion notification message 611. The RAN Node may use the establishment cause, the data session identifier(s), and network function identifier(s) or network function type(s) that were provided in the RRC request message 612 to determine that the RRC request message 612 is related to the congestion situation that the RAN Node was notified about in congestion notification message 611.

For example, the congestion notification message 611 may have indicated that all of a WTRU's traffic is associated with a congestion situation or the congestion notification of step 2 may have indicated that all traffic that is associated with the PDU Session (i.e. the data session) is associated with a congestion situation. The RRC request message 612 may be a request to send user plane data for a WTRU that was identified in the congestion notification message 611 or a WTRU that is a member of a group of WTRUs that was identified the congestion notification message 611. The RAN Node may then determine to respond in the RRC response message 613 with an indication of congestion and a back off timer value. The back off timer value may be based on the time value that was received in the congestion notification message 611 and how much time passed since receiving the congestion notification message 611.

In 614, the WTRU may apply the back off timer value that was received in the RRC response message 613. Applying the back off timer value may mean that the WTRU may configure a timer based on the received back off timer value and, when the timer expires, attempts again to establish an RRC connection.

In 615, the WTRU may attempt again to establish an RRC Connection by sending an RRC request message.

In 616, since the congestion situation has ended, the RAN Node may respond to the WTRU with an indication that an RRC Connection has been established in an RRC response message.

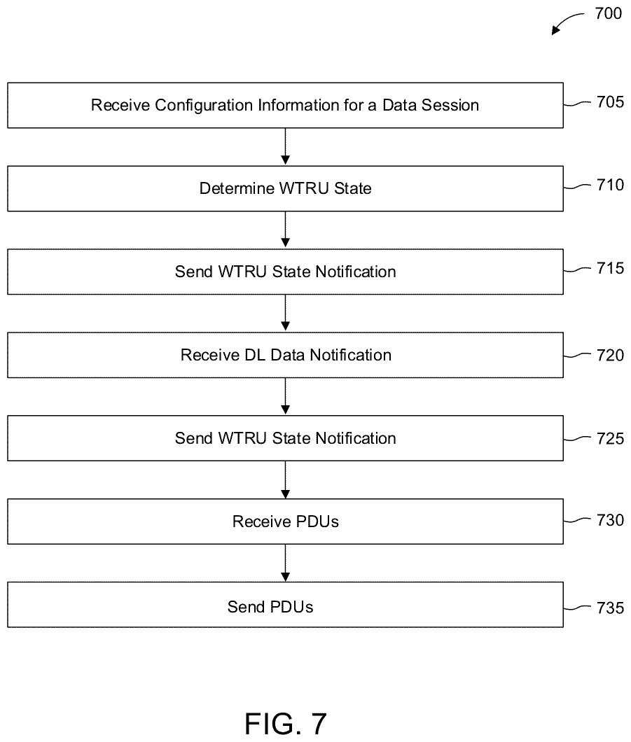

FIG. 7 shows example method 700 for user plane downlink data delivery when a WTRU is in an IDLE mode. A UPF may communicate directly with a RAN Node in order to coordinate the WTRU's change to a CONNECTED mode.

A RAN Node may receive configuration information for a data session of a WTRU (e.g. a data session configuration information message) 705 from an SMF. This is similar to 213 of FIG. 2. The configuration information may be used to communicate with a UPF. The configuration information may include information that may be used to send and receive data from a UPF. For example, the configuration information may be tunnel endpoint information that may be used to establish a tunnel between the RAN Node and the UPF. The configuration information may also include how to map downlink QoS flows to radio resources so that PDUs may be sent to a WTRU. The configuration information for the data session may indicate to the RAN Node how many PDUs, or how much data, the RAN Node should/may buffer for the WTRU when the WTRU is in an IDLE state. The amount of data to buffer (e.g. in terms of PDUs or bytes) may be provided to the RAN node on a per data session or a per QoS flow basis.

The RAN Node may determine a state of the WTRU or determine that the state of the WTRU has changed 710. The RAN Node may determine or detect that the WTRU is in an IDLE state or an INACTIVE state. The RAN Node may receive a notification (e.g. state change notification message) from the WTRU indicating that the WTRU is in a particular state. This is similar to 219 of FIG. 2. The state change notification may indicate that the WTRU has entered an IDLE or INACTIVE state. The WTRU may send the notification to the RAN Node based on the WTRU not sending or receiving data for a period of time. The RAN Node may send to the WTRU a command to enter a state (e.g. IDLE state). The RAN Node may send the command to the WTRU based on the WTRU not sending or receiving data for a period of time. The RAN Node may determine the state of the WTRU based on the state change notification message received from the WTRU. The RAN Node may determine the state of the WTRU based on the command to enter a state sent by the RAN Node to the WTRU. The WTRU may exit this state by sending uplink traffic or sending a message to the network (e.g. sending an RRC message to a base station or gNB) The RRC message may carry a NAS message that is addressed to a core network node such as an AMF or SMF. The network may trigger the WTRU to exit this state by paging the WTRU (e.g. sending a paging message to the WTRU).

Note that, at this point in the procedure, control plane nodes in the core network may not be aware that the WTRU is in an IDLE or INACTIVE state. For example, network functions that perform mobility management, such as the AMF, do not need to be aware that the WTRU is in an IDLE or INACTIVE state. For example, network functions that perform session management, such as the SMF, do not need to be aware that the WTRU is in an IDLE or INACTIVE state.

The RAN Node may send a state notification (e.g. state notification message) 715 to the UPF. This is similar to 220 of FIG. 2. The state notification may indicate the state of the WTRU. The state notification may indicate that the WTRU is in an IDLE state. The state notification may include the data session identifier or an identifier of the WTRU. The state notification message may indicate that the WTRU is in an IDLE state. The RAN Node may send the state notification message to the UPF when the RAN Node receives a message from the WTRU that indicates that the WTRU should go into an IDLE state. The RAN Node may send the state notification message to the UPF when the RAN Node sends a command to the WTRU and the command requests that the WTRU go into an IDLE state. The RAN Node may send the state notification message to the UPF based on expiration of a timer or time period. For example, the RAN Node may reset a timer each time it receives a message from the WTRU. Expiration of the timer may be an indication that the RAN Node has not received a message from the WTRU in a certain amount of time.

In a scenario where the RAN Node sends the state notification message to the UPF when the WTRU goes into an IDLE state, the RAN Node may be configured to only send the state notification message to the UPF if the WTRU's DRX cycle is longer than a certain length of time. For example, if the WTRU's DRX cycle is relatively short (e.g. less than 10.24 seconds), then the RAN Node may determine that the WTRU may be paged and moved to a CONNECTED state rather quickly if downlink data needs to be sent to the WTRU and therefore the UPF does not need to be notified that the WTRU is in an IDLE state. Thus, in a scenario where the RAN Node determines that the expected amount of time that it will take to transition the RAN Node out of the IDLE state is small (e.g. less than a threshold amount of time), the WTRU's state transitions can be “hidden” from the UPF, thus reducing the amount of messaging that is necessary between the RAN Node and UPF.

The state notification message from the RAN Node to the UPF may indicate to the UPF how many PDUs that the RAN Node is willing to buffer for a data session or for each QoS flow of a data session. The state notification message from the RAN Node to the UPF may indicate that how much (e.g. how many bytes) data the RAN Node is willing to buffer for a data session or for each QoS flow of a data session. This information may be used by the UPF to determine how many PDUs may be sent to the RAN Node before the UPF receives confirmation that the WTRU is in a CONNECTED state.

The state notification message from the RAN Node to the UPF may indicate an expected maximum amount of time that it will take for the WTRU to change back to a connected state. For example, this time value may be based on the size of the WTRU's DRX cycle. This time value may be used by the UPF to configure timers in the UPF that may be used to determine if an attempt to deliver a PDU has failed. For example, this time value may be based on a timer that has been configured in the WTRU by the network and expiration of the timer may cause the WTRU to transition to a connected state and send a message to the network.

The RAN Node may receive a downlink (DL) data notification (e.g. DL data notification message) 720 from the UPF. This is similar to 222 of FIG. 2. The UPF may be triggered to send the DL data notification to the RAN Node. The UPF may be triggered to send the DL data notification when the UPF receives one or more PDUs for a PDU session (e.g. as in 221 of FIG. 2). The DL data notification may include a QoS flow ID and/or a differentiated services code point (DSCP) value. The QoS flow ID and/or a DSCP value that are included in the DL data notification may be the QoS flow ID and/or a DSCP value that is associated with the PDU(s) that are received (e.g. in 221 of FIG. 2). The UPF may include the QoS flow ID and/or a DSCP value in the DL data notification so that the RAN Node knows the relative importance of the PDU. For example, if the QoS flow ID and/or a DSCP value is associated with traffic that may be an attempt to establish a voice session with the WTRU, then the RAN Node may consider the PDU to be associated with traffic that is higher in priority. It is advantageous for the RAN Node to know the importance, or relative priority, of the traffic because the RAN Node may consider the importance, or relative priority, when forming a paging strategy. For example, if traffic is higher in importance, or relative priority, then the RAN Node may decide to initially use more paging resources when attempting to page the WTRU. Paging resources refers to the area over which a paging message is transmitted (i.e. the number of cells) and the power with which it is transmitted. The PDU set importance value that is associated with the PDU may also be sent to the RAN Node so that the RAN Node may consider the PDU set importance when forming a paging strategy.

The DL Data Notification to the RAN Node may include a PDU (e.g. a PDU that was received as in 221 of FIG. 2). For example, if the RAN Node indicated in the state notification message 715 that the RAN Node is able to buffer at least one PDU, then the UPF may include the PDU when sending the DL data notification to the RAN Node. For example, if the SMF indicated that the RAN Node is able to buffer at least one PDU, then the UPF may include the PDU when sending the DL data notification to the RAN Node.

The RAN Node may send a DL data response (e.g. DL data response message) to the UPF. The DL data response may be sent to the UPF in response to the received DL data notification. The DL data response may indicate to the UPF a time value or estimate of how long the RAN Node expects it will take for the WTRU's state to change to a connected mode after the RAN Node triggers the WTRU's transition to a connected mode. For example, the RAN Node may calculate or determine the time until the WTRU's next paging occasion and include a value that is close to this time in the DL data response to the UPF. The DL data response may indicate to the UPF that the WTRU is not reachable. The DL data response may indicate to the UPF that the WTRU is in a connected mode and that the PDU was delivered to the WTRU. The indication that the PDU was delivered may be interpreted as an indication that the WTRU is in a connected mode. When the RAN Node indicates that the WTRU is in connected mode, the RAN Node may skip performing a paging procedure with the WTRU and may skip sending a WTRU state notification 725 to the UPF.

The RAN Node may perform a paging procedure with the WTRU. The RAN Node may determine that the WTRU has changed from an IDLE state to a CONNECTED state. The RAN Node may send a paging message to the WTRU. The WTRU may respond to the RAN Node with a message that represents a request that the WTRU be allowed to transition to the CONNECTED state. Reception of the response may trigger the RAN Node to send a message to the WTRU to confirm that the WTRU is now in a CONNECTED mode. A QoS Flow ID and/or a DSCP value may be used by the RAN Node to form a paging strategy. For example, the QoS Flow ID and/or a DSCP value may be used to determine which cells to use to broadcast a paging message and with what power to broadcast the paging message.

The RAN Node may send a WTRU state notification message 725 to the UPF. The WTRU state notification message may indicate to the UPF that the WTRU is now in a CONNECTED mode.

The RAN Node may receive one or more PDUs 730 from the UPF. The UPF may be triggered to send the PDUs when the UPF receives the WTRU state notification message which indicates that the WTRU is in a CONNECTED mode. The UPF may be triggered to send the PDUs when a timer expires. For example, the UPF may configure a timer when it receives the DL data response message. The timer may be configured based on the amount of time that the RAN Node indicated that it would take for the WTRU's state to change to a connected mode. An advantage of triggering to send the PDUs based on expiration of the timer may be that the WTRU state notification message would not be necessary.

The RAN Node may send the PDU(s) 730 that were received from the UPF to the WTRU.

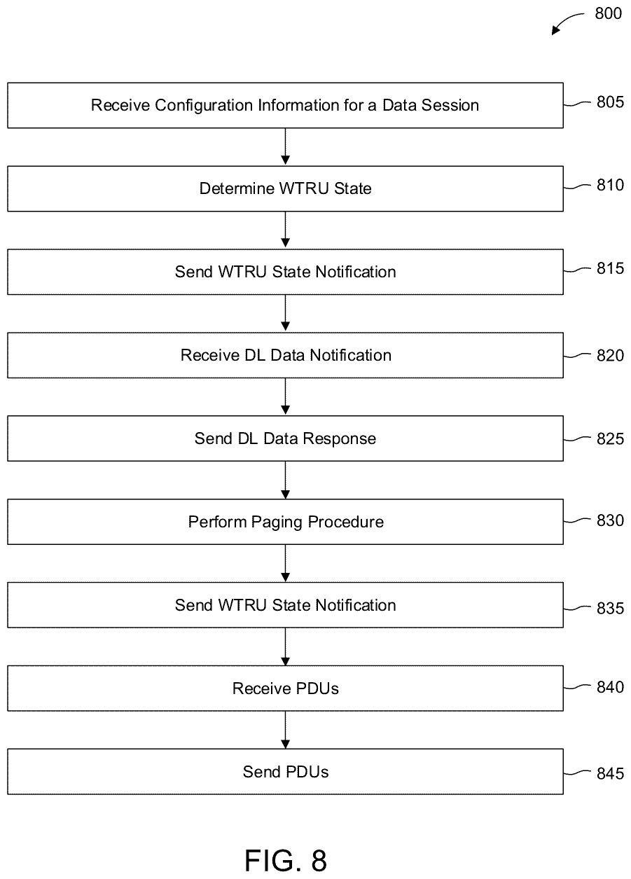

FIG. 8 shows example method 800 for user plane downlink data delivery when a WTRU is in an IDLE mode. A UPF may communicate directly with a RAN Node in order to coordinate the WTRU's change to a CONNECTED mode.

A RAN Node may receive configuration information for a data session of a WTRU (e.g. a data session configuration information message) 805 from an SMF. This is similar to 213 of FIG. 2. The configuration information may be used to communicate with a UPF. The configuration information may include information that may be used to send and receive data from a UPF. For example, the configuration information may be tunnel endpoint information that may be used to establish a tunnel between the RAN Node and the UPF. The configuration information may also include how to map downlink QoS flows to radio resources so that PDUs may be sent to a WTRU. The configuration information for the data session may indicate to the RAN Node how many PDUs, or how much data, the RAN Node should/may buffer for the WTRU when the WTRU is in an IDLE state. The amount of data to buffer (e.g. in terms of PDUs or bytes) may be provided to the RAN node on a per data session or a per QoS flow basis.

The RAN Node may determine a state of the WTRU or determine that the state of the WTRU has changed 810. The RAN Node may determine or detect that the WTRU is in an IDLE state or an INACTIVE state. The RAN Node may receive a notification (e.g. state change notification message) from the WTRU indicating that the WTRU is in a particular state. This is similar to 219 of FIG. 2. The state change notification may indicate that the WTRU has entered an IDLE or INACTIVE state. The WTRU may send the notification to the RAN Node based on the WTRU not sending or receiving data for a period of time. The RAN Node may send to the WTRU a command to enter a state (e.g. IDLE state). The RAN Node may send the command to the WTRU based on the WTRU not sending or receiving data for a period of time. The RAN Node may determine the state of the WTRU based on the state change notification message received from the WTRU. The RAN Node may determine the state of the WTRU based on the command to enter a state sent by the RAN Node to the WTRU. The WTRU may exit this state by sending uplink traffic or sending a message to the network (e.g. sending an RRC message to a base station or gNB) The RRC message may carry a NAS message that is addressed to a core network node such as an AMF or SMF. The network may trigger the WTRU to exit this state by paging the WTRU (e.g. sending a paging message to the WTRU).

Note that, at this point in the procedure, control plane nodes in the core network may not be aware that the WTRU is in an IDLE or INACTIVE state. For example, network functions that perform mobility management, such as the AMF, do not need to be aware that the WTRU is in an IDLE or INACTIVE state. For example, network functions that perform session management, such as the SMF, do not need to be aware that the WTRU is in an IDLE or INACTIVE state.

The RAN Node may send a state notification (e.g. state notification message) 815 to the UPF. This is similar to 220 of FIG. 2. The state notification may indicate the state of the WTRU. The state notification may indicate that the WTRU is in an IDLE state. The state notification may include the data session identifier or an identifier of the WTRU. The state notification message may indicate that the WTRU is in an IDLE state. The RAN Node may send the state notification message to the UPF when the RAN Node receives a message from the WTRU that indicates that the WTRU should go into an IDLE state. The RAN Node may send the state notification message to the UPF when the RAN Node sends a command to the WTRU and the command requests that the WTRU go into an IDLE state. The RAN Node may send the state notification message to the UPF based on expiration of a timer or time period. For example, the RAN Node may reset a timer each time it receives a message from the WTRU. Expiration of the timer may be an indication that the RAN Node has not received a message from the WTRU in a certain amount of time.

In a scenario where the RAN Node sends the state notification message to the UPF when the WTRU goes into an IDLE state, the RAN Node may be configured to only send the state notification message to the UPF if the WTRU's DRX cycle is longer than a certain length of time. For example, if the WTRU's DRX cycle is relatively short (e.g. less than 10.24 seconds), then the RAN Node may determine that the WTRU may be paged and moved to a CONNECTED state rather quickly if downlink data needs to be sent to the WTRU and therefore the UPF does not need to be notified that the WTRU is in an IDLE state. Thus, in a scenario where the RAN Node determines that the expected amount of time that it will take to transition the RAN Node out of the IDLE state is small (e.g. less than a threshold amount of time), the WTRU's state transitions can be “hidden” from the UPF, thus reducing the amount of messaging that is necessary between the RAN Node and UPF.

The state notification message from the RAN Node to the UPF may indicate to the UPF how many PDUs that the RAN Node is willing to buffer for a data session or for each QoS flow of a data session. The state notification message from the RAN Node to the UPF may indicate that how much (e.g. how many bytes) data the RAN Node is willing to buffer for a data session or for each QoS flow of a data session. This information may be used by the UPF to determine how many PDUs may be sent to the RAN Node before the UPF receives confirmation that the WTRU is in a CONNECTED state.

The state notification message from the RAN Node to the UPF may indicate an expected maximum amount of time that it will take for the WTRU to change back to a connected state. For example, this time value may be based on the size of the WTRU's DRX cycle. This time value may be used by the UPF to configure timers in the UPF that may be used to determine if an attempt to deliver a PDU has failed. For example, this time value may be based on a timer that has been configured in the WTRU by the network and expiration of the timer may cause the WTRU to transition to a connected state and send a message to the network.

The RAN Node may receive a downlink (DL) data notification (e.g. DL data notification message) 820 from the UPF. This is similar to 222 of FIG. 2. The UPF may be triggered to send the DL data notification to the RAN Node. The UPF may be triggered to send the DL data notification when the UPF receives one or more PDUs for a PDU session (e.g. as in 221 of FIG. 2). The DL data notification may include a QoS flow ID and/or a differentiated services code point (DSCP) value. The QoS flow ID and/or a DSCP value that are included in the DL data notification may be the QoS flow ID and/or a DSCP value that is associated with the PDU(s) that are received (e.g. in 221 of FIG. 2). The UPF may include the QoS flow ID and/or a DSCP value in the DL data notification so that the RAN Node knows the relative importance of the PDU. For example, if the QoS flow ID and/or a DSCP value is associated with traffic that may be an attempt to establish a voice session with the WTRU, then the RAN Node may consider the PDU to be associated with traffic that is higher in priority. It is advantageous for the RAN Node to know the importance, or relative priority, of the traffic because the RAN Node may consider the importance, or relative priority, when forming a paging strategy. For example, if traffic is higher in importance, or relative priority, then the RAN Node may decide to initially use more paging resources when attempting to page the WTRU. Paging resources refers to the area over which a paging message is transmitted (i.e. the number of cells) and the power with which it is transmitted. The PDU set importance value that is associated with the PDU may also be sent to the RAN Node so that the RAN Node may consider the PDU set importance when forming a paging strategy.

The DL Data Notification to the RAN Node may include a PDU (e.g. a PDU that was received as in 221 of FIG. 2). For example, if the RAN Node indicated in the state notification 815 that the RAN Node is able to buffer at least one PDU, then the UPF may include the PDU when sending the DL data notification to the RAN Node. For example, if the SMF indicated that the RAN Node is able to buffer at least one PDU, then the UPF may include the PDU when sending the DL data notification to the RAN Node.

The RAN Node may send a DL data response (e.g. DL data response message) 825 to the UPF. The DL data response may be sent to the UPF in response to the received DL data notification. The DL data response may indicate to the UPF a time value or estimate of how long the RAN Node expects it will take for the WTRU's state to change to a connected mode after the RAN Node triggers the WTRU's transition to a connected mode. For example, the RAN Node may calculate or determine the time until the WTRU's next paging occasion and include a value that is close to this time in the DL data response to the UPF. The DL data response may indicate to the UPF that the WTRU is not reachable. The DL data response may indicate to the UPF that the WTRU is in a connected mode and that the PDU was delivered to the WTRU. The indication that the PDU was delivered may be interpreted as an indication that the WTRU is in a connected mode. When the RAN Node indicates that the WTRU is in connected mode, the RAN Node may skip performing a paging procedure 830 with the WTRU and may skip sending a WTRU state notification 835 to the UPF.

The RAN Node may perform a paging procedure 830 with the WTRU. The RAN Node may determine that the WTRU has changed from an IDLE state to a CONNECTED state. The RAN Node may send a paging message to the WTRU. The WTRU may respond to the RAN Node with a message that represents a request that the WTRU be allowed to transition to the CONNECTED state. Reception of the response may trigger the RAN Node to send a message to the WTRU to confirm that the WTRU is now in a CONNECTED mode. A QoS Flow ID and/or a DSCP value may be used by the RAN Node to form a paging strategy. For example, the QoS Flow ID and/or a DSCP value may be used to determine which cells to use to broadcast a paging message and with what power to broadcast the paging message.

The RAN Node may send a WTRU state notification message 835 to the UPF. The WTRU state notification message may indicate to the UPF that the WTRU is now in a CONNECTED mode.

The RAN Node may receive one or more PDUs 840 from the UPF. The UPF may be triggered to send the PDUs when the UPF receives the WTRU state notification message which indicates that the WTRU is in a CONNECTED mode. The UPF may be triggered to send the PDUs when a timer expires. For example, the UPF may configure a timer when it receives the DL data response message. The timer may be configured based on the amount of time that the RAN Node indicated that it would take for the WTRU's state to change to a connected mode. An advantage of triggering to send the PDUs based on expiration of the timer may be that the WTRU state notification message would not be necessary.

The RAN Node may send the PDU(s) 845 that were received from the UPF to the WTRU.

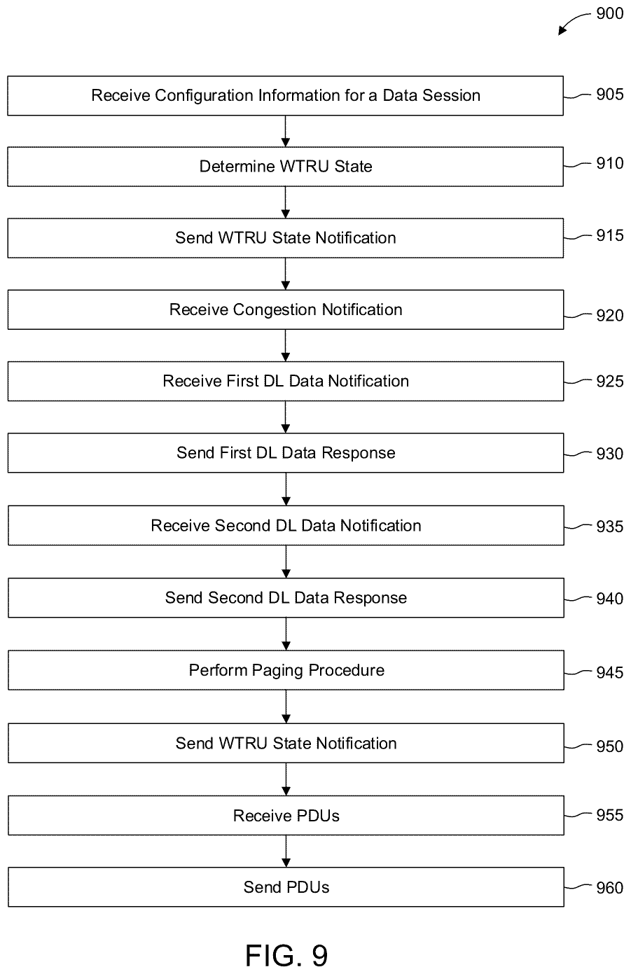

FIG. 9 shows an example method 900 for user plane downlink data delivery with congestion when a WTRU is in an IDLE mode.

A RAN Node may receive configuration information for a data session of a WTRU (e.g. a data session configuration information message) 905 from an SMF. This is similar to 213 of FIG. 2. The configuration information may be used to communicate with a UPF. The configuration information may include information that may be used to send and receive data from a UPF. For example, the configuration information may be tunnel endpoint information that may be used to establish a tunnel between the RAN Node and the UPF. The configuration information may also include how to map downlink QoS flows to radio resources so that PDUs may be sent to a WTRU. The configuration information for the data session may indicate to the RAN Node how many PDUs, or how much data, the RAN Node should/may buffer for the WTRU when the WTRU is in an IDLE state. The amount of data to buffer (e.g. in terms of PDUs or bytes) may be provided to the RAN node on a per data session or a per QoS flow basis.

The RAN Node may determine a state of the WTRU or determine that the state of the WTRU has changed 910. The RAN Node may determine or detect that the WTRU is in an IDLE state or an INACTIVE state. The RAN Node may receive a notification (e.g. state change notification message) from the WTRU indicating that the WTRU is in a particular state. This is similar to 219 of FIG. 2. The state change notification may indicate that the WTRU has entered an IDLE or INACTIVE state. The WTRU may send the notification to the RAN Node based on the WTRU not sending or receiving data for a period of time. The RAN Node may send to the WTRU a command to enter a state (e.g. IDLE state). The RAN Node may send the command to the WTRU based on the WTRU not sending or receiving data for a period of time. The RAN Node may determine the state of the WTRU based on the state change notification message received from the WTRU. The RAN Node may determine the state of the WTRU based on the command to enter a state sent by the RAN Node to the WTRU. The WTRU may exit this state by sending uplink traffic or sending a message to the network (e.g. RRC message to a based station or gNB). The RRC message may carry a NAS message that is addressed to a core network node such as an AMF or SMF. The network may trigger the WTRU to exit this state by paging the WTRU (e.g. sending a paging message to the WTRU).

Note that, at this point in the procedure, control plane nodes in the core network may not be aware that the WTRU is in an IDLE or INACTIVE state. For example, network functions that perform mobility management, such as the AMF, do not need to be aware that the WTRU is in an IDLE or INACTIVE state. For example, network functions that perform session management, such as the SMF, do not need to be aware that the WTRU is in an IDLE or INACTIVE state.

The RAN Node may send a state notification (e.g. state notification message) 915 to the UPF. This is similar to 220 of FIG. 2. The state notification may indicate the state of the WTRU. The state notification may indicate that the WTRU is in an IDLE state. The state notification may include the data session identifier or an identifier of the WTRU. The state notification message may indicate that the WTRU is in an IDLE state. The RAN Node may send the state notification message to the UPF when the RAN Node receives a message from the WTRU that indicates that the WTRU should go into an IDLE state. The RAN Node may send the state notification message to the UPF when the RAN Node sends a command to the WTRU and the command requests that the WTRU go into an IDLE state. The RAN Node may send the state notification message to the UPF based on expiration of a timer or time period. For example, the RAN Node may reset a timer each time it receives a message from the WTRU. Expiration of the timer may be an indication that the RAN Node has not received a message from the WTRU in a certain amount of time.

In a scenario where the RAN Node sends the state notification message to the UPF when the WTRU goes into an IDLE state, the RAN Node may be configured to only send the state notification message to the UPF if the WTRU's DRX cycle is longer than a certain length of time. For example, if the WTRU's DRX cycle is relatively short (e.g. less than 10.24 seconds), then the RAN Node may determine that the WTRU may be paged and moved to a CONNECTED state rather quickly if downlink data needs to be sent to the WTRU and therefore the UPF does not need to be notified that the WTRU is in an IDLE state. Thus, in a scenario where the RAN Node determines that the expected amount of time that it will take to transition the RAN Node out of the IDLE state is small (e.g. less than a threshold amount of time), the WTRU's state transitions can be “hidden” from the UPF, thus reducing the amount of messaging that is necessary between the RAN Node and UPF.

The state notification message from the RAN Node to the UPF may indicate to the UPF how many PDUs that the RAN Node is willing to buffer for a data session or for each QoS flow of a data session. The state notification message from the RAN Node to the UPF may indicate that how much (e.g. how many bytes) data the RAN Node is willing to buffer for a data session or for each QoS flow of a data session. This information may be used by the UPF to determine how many PDUs may be sent to the RAN Node before the UPF receives confirmation that the WTRU is in a CONNECTED state.

The state notification message from the RAN Node to the UPF may indicate an expected maximum amount of time that it will take for the WTRU to change back to a connected state. For example, this time value may be based on the size of the WTRU's DRX cycle. This time value may be used by the UPF to configure timers in the UPF that may be used to determine if an attempt to deliver a PDU has failed. For example, this time value may be based on a timer that has been configured in the WTRU by the network and expiration of the timer may cause the WTRU to transition to a connected state and send a message to the network.

The RAN Node may receive a congestion notification (e.g. congestion notification message) 920. The congestion notification may be received from a network function (NF) (e.g. CP Node). The congestion notification may indicate that the WTRU and/or the data session is associated with a congestion situation.

The congestion notification message may include a time value that represents how long the RAN Node should assume that the congestion situation applies. Before the congestion time expires, the NF may notify the RAN Node that the congestion situation has be resolved or the NF may extend the congestion time.

The NF may be an SMF or a PCF. The SMF or PCF may include a data session identifier (e.g. a PDU Session Identifier) in the congestion notification message to which the congestion notification applies.

The NF may be an AMF. The AMF may include a WTRU identifier or an identifier of a group of WTRUs in the congestion notification message to which the congestion notification applies.

The NF may be an SMSF. The SMSF may include a WTRU identifier or an identifier of a group of WTRUs in the congestion notification message to which the congestion notification applies. Furthermore, the congestion notification message may indicate that the congestion only applies to traffic that is directed to the SMSF, certain SMSFs, or certain networks.

The NF may be a PCF. The PCF may include a WTRU identifier or an identifier of a group of WTRUs in the congestion notification message to which the congestion notification applies. Furthermore, the congestion notification message may indicate that the congestion only applies to traffic that is directed to the PCF or certain PCFs.

The RAN Node may receive a first downlink (DL) data notification (e.g. first DL data notification message) 925 from the UPF. This is similar to 222 of FIG. 2. The UPF may be triggered to send the first DL data notification to the RAN Node. The UPF may be triggered to send the first DL data notification when the UPF receives one or more PDUs for a PDU session (e.g. as in 221 of FIG. 2). The first DL data notification may include a QoS flow ID and/or a differentiated services code point (DSCP) value. The QoS flow ID and/or a DSCP value that are included in the first DL data notification may be the QoS flow ID and/or a DSCP value that is associated with the PDU(s) that are received (e.g. in 221 of FIG. 2). The UPF may include the QoS flow ID and/or a DSCP value in the first DL data notification so that the RAN Node knows the relative importance of the PDU. For example, if the QoS flow ID and/or a DSCP value is associated with traffic that may be an attempt to establish a voice session with the WTRU, then the RAN Node may consider the PDU to be associated with traffic that is higher in priority. It is advantageous for the RAN Node to know the importance, or relative priority, of the traffic because the RAN Node may consider the importance, or relative priority, when forming a paging strategy. For example, if traffic is higher in importance, or relative priority, then the RAN Node may decide to initially use more paging resources when attempting to page the WTRU. Paging resources refers to the area over which a paging message is transmitted (i.e. the number of cells) and the power with which it is transmitted. The PDU set importance value that is associated with the PDU may also be sent to the RAN Node so that the RAN Node may consider the PDU set importance when forming a paging strategy.

The first DL data notification to the RAN Node may include a PDU (e.g. a PDU that was received as in 221 of FIG. 2). For example, if the RAN Node indicated in the state notification 915 that the RAN Node is able to buffer at least one PDU, then the UPF may include the PDU when sending the first DL data notification to the RAN Node. For example, if the SMF indicated that the RAN Node is able to buffer at least one PDU, then the UPF may include the PDU when sending the first DL data notification to the RAN Node.

The RAN Node may send a first DL data response (e.g. first DL data response message) 930 to the UPF. Before sending the first DL data response message, the RAN Node may determine that the first DL data notification 925 is related to the congestion situation that the RAN Node was notified about in the congestion notification message 920. The first DL data response may indicate to the UPF that the WTRU or data session is associated with a congestion situation. The first DL data response may indicates a back off time value to the UPF.

For example, the congestion notification message 920 may have indicated that all of a WTRU's traffic is associated with a congestion situation or the congestion notification message 920 may have indicated that all traffic that is associated with the PDU Session (i.e. the data session) is associated with a congestion situation. The first DL data notification 925 may be a request to send user plane data for a WTRU that was identified in the congestion notification message 920 or a WTRU that is a member of a group of WTRUs that was identified in the congestion notification message 920. The RAN Node may then determine to respond in the first DL data response message 930 with an indication of congestion and a back off time value. The back off time value may be based on the time value that was received in the congestion notification message 920 and how much time passed since receiving the congestion notification message 920.

A re-attempt of the initiation of the DL data delivery may be performed.

The RAN Node may receive a second DL data notification (e.g. second DL data notification message) 935 from the UPF. This is similar to 222 of FIG. 2. The UPF may be triggered to send the second DL data notification to the RAN Node. The UPF may be triggered to send the second DL data notification when the UPF receives one or more PDUs for a PDU session (e.g. as in 221 of FIG. 2). The second DL data notification may include a QoS flow ID and/or a differentiated services code point (DSCP) value. The QoS flow ID and/or a DSCP value that are included in the second DL data notification may be the QoS flow ID and/or a DSCP value that is associated with the PDU(s) that are received (e.g. in 221 of FIG. 2). The UPF may include the QoS flow ID and/or a DSCP value in the second DL data notification so that the RAN Node knows the relative importance of the PDU. For example, if the QoS flow ID and/or a DSCP value is associated with traffic that may be an attempt to establish a voice session with the WTRU, then the RAN Node may consider the PDU to be associated with traffic that is higher in priority. It is advantageous for the RAN Node to know the importance, or relative priority, of the traffic because the RAN Node may consider the importance, or relative priority, when forming a paging strategy. For example, if traffic is higher in importance, or relative priority, then the RAN Node may decide to initially use more paging resources when attempting to page the WTRU. Paging resources refers to the area over which a paging message is transmitted (i.e. the number of cells) and the power with which it is transmitted. The PDU set importance value that is associated with the PDU may also be sent to the RAN Node so that the RAN Node may consider the PDU set importance when forming a paging strategy.

The second DL data notification to the RAN Node may include a PDU (e.g. a PDU that was received as in 221 of FIG. 2). For example, if the RAN Node indicated in the state notification 915 that the RAN Node is able to buffer at least one PDU, then the UPF may include the PDU when sending the second DL data notification to the RAN Node. For example, if the SMF indicated that the RAN Node is able to buffer at least one PDU, then the UPF may include the PDU when sending the second DL data notification to the RAN Node.

The RAN Node may send a second DL data response (e.g. second DL data response message) 940 to the UPF. The second DL data response may be sent to the UPF in response to the received DL data notification. The second DL data response may indicate to the UPF a time value or estimate of how long the RAN Node expects it will take for the WTRU's state to change to a connected mode after the RAN Node triggers the WTRU's transition to a connected mode. For example, the RAN Node may calculate or determine the time until the WTRU's next paging occasion and include a value that is close to this time in the DL data response to the UPF. The DL data response may indicate to the UPF that the WTRU is not reachable. The DL data response may indicate to the UPF that the WTRU is in a connected mode and that the PDU was delivered to the WTRU. The indication that the PDU was delivered may be interpreted as an indication that the WTRU is in a connected mode. When the RAN Node indicates that the WTRU is in connected mode, the RAN Node may skip performing a paging procedure 945 with the WTRU and may skip sending a WTRU state notification message 950 to the UPF.

The RAN Node may perform a paging procedure 945 with the WTRU. The RAN Node may determine that the WTRU has changed from an IDLE state to a CONNECTED state. The RAN Node may send a paging message to the WTRU. The WTRU may respond to the RAN Node with a message that represents a request that the WTRU be allowed to transition to the CONNECTED state. Reception of the response may trigger the RAN Node to send a message to the WTRU to confirm that the WTRU is now in a CONNECTED mode. A QoS Flow ID and/or a DSCP value may be used by the RAN Node to form a paging strategy. For example, the QoS Flow ID and/or a DSCP value may be used to determine which cells to use to broadcast a paging message and with what power to broadcast the paging message.

The RAN Node may send a WTRU state notification message 950 to the UPF. The WTRU state notification message may indicate to the UPF that the WTRU is now in a CONNECTED mode.

The RAN Node may receive one or more PDUs 955 from the UPF. The UPF may be triggered to send the PDUs when the UPF receives the WTRU state notification message which indicates that the WTRU is in a CONNECTED mode. The UPF may be triggered to send the PDUs when a timer expires. For example, the UPF may configure a timer when it receives the DL data response message. The timer may be configured based on the amount of time that the RAN Node indicated that it would take for the WTRU's state to change to a connected mode. An advantage of triggering to send the PDUs based on expiration of the timer may be that the WTRU state notification message would not be necessary.

The RAN Node may send the PDU(s) 960 that were received from the UPF to the WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by a radio access network (RAN) node, the method comprising:
receiving, from a session management function (SMF), configuration information for a data session for a wireless transmit/receive unit (WTRU);
determining a current state of the WTRU;
sending, to a user plane function (UPF), a first WTRU state notification message that indicates the current state of the WTRU, wherein the current state is an Idle state or an Inactive state;
receiving, from the UPF, a downlink (DL) data notification message indicating that the UPF has at least one protocol data unit (PDU) to send to the WTRU;
sending, to the UPF, a second WTRU state notification message that indicates that the WTRU is in a connected state;
receiving, from the UPF, the at least one PDU; and
forwarding, to the WTRU, the at least one PDU.

2. The method of claim 1, wherein the configuration information for a data session is used to communicate with the UPF.

3. The method of claim 1, wherein the first WTRU state notification message comprises a data session identifier (ID) and a WTRU ID.

4. The method of claim 1, wherein the first WTRU state notification message indicates a number of PDUs that the RAN is capable of buffering for the data session for a quality of service (QoS) flow of the data session.

5. The method of claim 1, wherein the DL data notification message comprises a QoS flow identifier (ID) and a differentiated services code point (DSCP) value.

6. The method of claim 5, further comprising:
determining paging resources to send a paging message based on the QoS flow ID and the DSCP value; and
sending, to the WTRU, the paging message.

7. The method of claim 6, wherein the paging resources include what cells to use to broadcast the paging message and at what power to broadcast the paging message.

8. The method of claim 1, wherein the DL data notification message includes the at least one PDU to send to the WTRU.

9. The method of claim 1, further comprising:
sending, to the UPF, a DL data response message, wherein the DL data response message indicates an estimate of time for the WTRU's state to change to a Connected state.

10. The method of claim 1, further comprising:
determining that the WTRU is in a connected state; and
forwarding the at least one PDU in response to the determination that the WTRU is in a connected state.

11. A radio access network (RAN) node comprising:
a receiver; and
a transmitter, wherein:
the receiver is configured to receive, from a session management function (SMF), configuration information for a data session for a wireless transmit/receive unit (WTRU);
the receiver is further configured to determining a current state of the WTRU;
the transmitter is configured to send, to a user plane function (UPF), a first WTRU state notification message that indicates the current state of the WTRU, wherein the current state is an Idle state or an Inactive state;
the receiver is further configured to receive, from the UPF, a downlink (DL) data notification message indicating that the UPF has at least one protocol data unit (PDU) to send to the WTRU;
the transmitter is further configured to send, to the UPF, a second WTRU state notification message that indicates that the WTRU is in a connected state;
the receiver is further configured to receive, from the UPF, the at least one PDU; and
the transmitter is further configured to forward, to the WTRU, the at least one PDU.

12. The RAN node of claim 11, wherein the configuration information for a data session is used to communicate with the UPF.

13. The RAN node of claim 11, wherein the first WTRU state notification message comprises a data session identifier (ID) and a WTRU ID.

14. The RAN node of claim 11, wherein the first WTRU state notification message indicates a number of PDUs that the RAN is capable of buffering for the data session for a quality of service (QoS) flow of the data session.

15. The RAN node of claim 11, wherein the DL data notification message comprises a QoS flow identifier (ID) and a differentiated services code point (DSCP) value.

16. The RAN node of claim 15, further comprising:
a processor configured to determine paging resources to send a paging message based on the QoS flow ID and the DSCP value; and
the transmitter is further configured to send, to the WTRU, the paging message.

17. The RAN node of claim 16, wherein the paging resources include what cells to use to broadcast the paging message and at what power to broadcast the paging message.

18. The RAN node of claim 11, wherein the DL data notification message includes the at least one PDU to send to the WTRU.

19. The RAN node of claim 11, wherein:
the transmitter is further configured to send, to the UPF, a DL data response message, wherein the DL data response message indicates an estimate of time for the WTRU's state to change to a connected state.

20. The RAN node of claim 11, further comprising:
a processor configured to determine that the WTRU is in a connected state; and
the transmitter further configured to forward the at least one PDU in response to the determination that the WTRU is in a Connected state.
